(19) United States
(12) Patent Application Publication
(10) Pub. No.: US 2026/0205850 A1
(43) Pub. Date: Jul. 16, 2026

(54) APERIODIC MEASUREMENT REPORTING CAPABILITY FOR CHANNEL MEASUREMENT RESOURCES

(71) Applicant: QUALCOMM Incorporated, San Diego, CA (US)

(72) Inventors: Qiaoyu LI, Beijing (CN); Arumugam CHENDAMARAI KANNAN, San Diego, CA (US); Mahmoud TAHERZADEH BOROUJENI, San Diego, CA (US); Hamed PEZESHKI, SAN DIEGO, CA (US); Tao LUO, San Diego, CA (US)

(21) Appl. No.: 19/134,647

(22) PCT Filed: Feb. 2, 2023
(86) PCT No.: PCT/CN2023/074187

§ 371 Date: May 30, 2025

(51) Int. Cl. H04W 24/10; H04B 7/06; H04W 72/23

(52) U.S. Cl. CPC H04W 24/10; H04B 7/0626; H04W 72/23

(57) ABSTRACT

Methods, systems, and devices for method for wireless communication are described. A user equipment (UE) may transmit capability information indicating that the UE supports reception of a downlink control information signal triggering a measurement report prior to or after a time duration comprising one or more measurement occasions associated with a set of channel measurement resources. In some examples, a respective measurement information for each channel measurement resource of the set of channel measurement resources may be a candidate for inclusion in the measurement report for transmission. The UE may receive the downlink control information signal triggering the measurement report prior to or after the time duration in accordance with the capability information, and may transmit the measurement report in response to receiving the downlink control information signal.

### CROSS REFERENCE

The present Application for Patent is a 371 national phase filing of International Patent Application No. PCT/CN2023/074187 by LI et al., entitled “APERIODIC MEASUREMENT REPORTING CAPABILITY FOR CHANNEL MEASUREMENT RESOURCES,” filed Feb. 2, 2023, assigned to the assignee hereof, and expressly incorporated by reference herein.

### FIELD OF TECHNOLOGY

The following relates to method for wireless communication, including aperiodic measurement reporting for channel measurement resources.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support aperiodic measurement reporting for channel measurement resources. For example, the described techniques provide for techniques for a user equipment (UE) to indicate a capability of the UE to receive a control signal triggering a measurement report prior to or after one or more measurement occasions. In some examples, a network entity may transmit a control signal triggering a measurement report for channel measurement resources included in one or more measurement occasions. The UE may transmit capability information indicating that the UE supports reception of the control signal triggering the measurement report prior to or after a time duration including one or more measurement occasions associated with a set of channel measurement resources. In some examples, a respective measurement information for each channel measurement resource of the set of channel measurement resources may be a candidate for inclusion in the measurement report for transmission. For example, the network entity may request measurement information for one or more of the set of channel measurement resources included in the time duration. The capability indication may reduce signaling overhead at the UE and improve the efficiency of communications between the UE and the network entity.

A method for wireless communication at a user equipment (UE) is described. The method may include transmitting capability information indicating that the UE supports reception of a downlink control information signal triggering a measurement report prior to or after a time duration including one or more measurement occasions associated with a set of channel measurement resources, where a respective measurement information for each channel measurement resource of the set of channel measurement resources is a candidate for inclusion in the measurement report for transmission, receiving the downlink control information signal triggering the measurement report prior to or after the time duration in accordance with the capability information, and transmitting the measurement report in response to receiving the downlink control information signal.

An apparatus for wireless communication at a UE is described. The apparatus may include a processor, memory coupled with the processor, and instructions stored in the memory. The instructions may be executable by the processor to cause the apparatus to transmit capability information indicating that the UE supports reception of a downlink control information signal triggering a measurement report prior to or after a time duration including one or more measurement occasions associated with a set of channel measurement resources, where a respective measurement information for each channel measurement resource of the set of channel measurement resources is a candidate for inclusion in the measurement report for transmission, receive the downlink control information signal triggering the measurement report prior to or after the time duration in accordance with the capability information, and transmit the measurement report in response to receiving the downlink control information signal.

Another apparatus for wireless communication at a UE is described. The apparatus may include means for transmitting capability information indicating that the UE supports reception of a downlink control information signal triggering a measurement report prior to or after a time duration including one or more measurement occasions associated with a set of channel measurement resources, where a respective measurement information for each channel measurement resource of the set of channel measurement resources is a candidate for inclusion in the measurement report for transmission, means for receiving the downlink control information signal triggering the measurement report prior to or after the time duration in accordance with the capability information, and means for transmitting the measurement report in response to receiving the downlink control information signal.

A non-transitory computer-readable medium storing code for wireless communication at a UE is described. The code may include instructions executable by a processor to transmit capability information indicating that the UE supports reception of a downlink control information signal triggering a measurement report prior to or after a time duration including one or more measurement occasions associated with a set of channel measurement resources, where a respective measurement information for each channel measurement resource of the set of channel measurement resources is a candidate for inclusion in the measurement report for transmission, receive the downlink control information signal triggering the measurement report prior to or after the time duration in accordance with the capability information, and transmit the measurement report in response to receiving the downlink control information signal.

In some examples of the method, apparatuses, and non-transitory computer-readable medium described herein, transmitting the capability information may include operations, features, means, or instructions for transmitting, via the capability information, an indication that the UE supports reception of the downlink control information signal triggering the measurement report both prior to and after the time duration.

Some examples of the method, apparatuses, and non-transitory computer-readable medium described herein may further include operations, features, means, or instructions for transmitting a further capability information indicating a total number of channel measurement resources associated with the measurement report supported by the UE.

In some examples of the method, apparatuses, and non-transitory computer-readable medium described herein, the set of channel measurement resources may be a subset of the total number of channel measurement resources. In some examples of the method, apparatuses, and non-transitory computer-readable medium described herein, the total number of channel measurement resources may be based on an average number of channel measurement resources per time duration.

In some examples of the method, apparatuses, and non-transitory computer-readable medium described herein, transmitting the capability information may include operations, features, means, or instructions for transmitting, via the capability information, an indication that the UE supports reception of the downlink control information signal triggering the measurement report prior to or after the time duration, where the UE supporting reception of the downlink control information signal after the time duration may be based at least part on reception of a prior signal from a network entity, and where the prior signal indicates that the UE may be to expect the downlink control information signal after the time duration.

Some examples of the method, apparatuses, and non-transitory computer-readable medium described herein may further include operations, features, means, or instructions for receiving a medium access control layer control element (MAC-CE) indicating a set of channel state information triggering states corresponding to the set of channel measurement resources.

Some examples of the method, apparatuses, and non-transitory computer-readable medium described herein may further include operations, features, means, or instructions for receiving a first medium access control layer control element (MAC-CE) indicating a set of channel state information triggering states and receiving a second media access control (MAC)-CE indicating a subset of the set of channel state information triggering states, where the subset of the set of channel state information triggering states corresponds to the set of channel measurement resources.

Some examples of the method, apparatuses, and non-transitory computer-readable medium described herein may further include operations, features, means, or instructions for transmitting a further capability information indicating a threshold discontinuous reception periodicity, where the UE supporting reception of the downlink control information signal after the time duration may be based at least part on the threshold discontinuous reception periodicity.

Some examples of the method, apparatuses, and non-transitory computer-readable medium described herein may further include operations, features, means, or instructions for transmitting a further capability information indicating a minimum time duration between a last symbol carrying the downlink control information signal and a starting symbol for the one or more measurement occasions associated with the set of channel measurement resources. In some examples of the method, apparatuses, and non-transitory computer-readable medium described herein, the minimum time duration may be based on a quantity of channel measurement resources in the set of channel measurement resources.

In some examples of the method, apparatuses, and non-transitory computer-readable medium described herein, transmitting the capability information may include operations, features, means, or instructions for transmitting, via the capability information, an indication that the UE supports reception of the downlink control information signal triggering the measurement report prior to the time duration.

Some examples of the method, apparatuses, and non-transitory computer-readable medium described herein may further include operations, features, means, or instructions for transmitting a further capability information indicating at least one of a minimum time duration between a last symbol carrying the downlink control information signal and a starting symbol for the one or more measurement occasions associated with the set of channel measurement resources, a threshold discontinuous reception periodicity, or a combination thereof.

In some examples of the method, apparatuses, and non-transitory computer-readable medium described herein, the downlink control information signal may be received prior to the minimum time duration between the last symbol carrying the downlink control information and the starting symbol for the one or more measurement occasions associated with the set of channel measurement resources.

In some examples of the method, apparatuses, and non-transitory computer-readable medium described herein, the UE receives the downlink control information signal prior to the time duration based at least part on a discontinuous reception periodicity for the time duration being greater than the threshold discontinuous reception periodicity.

A method for wireless communication at a network entity is described. The method may include receiving a capability information indicating that a UE supports reception of a downlink control information signal triggering a measurement report prior to or after a time duration including one or more measurement occasions associated with a set of channel measurement resources, where a respective measurement information for each channel measurement resource of the set of channel measurement resources is a candidate for inclusion in the measurement report for transmission to the network entity, transmitting the downlink control information signal triggering the measurement report prior to or after the time duration in accordance with the capability information, and receiving the measurement report in response to receiving the downlink control information signal.

An apparatus for wireless communication at a network entity is described. The apparatus may include a processor, memory coupled with the processor, and instructions stored in the memory. The instructions may be executable by the processor to cause the apparatus to receive a capability information indicating that a UE supports reception of a downlink control information signal triggering a measurement report prior to or after a time duration including one or more measurement occasions associated with a set of channel measurement resources, where a respective measurement information for each channel measurement resource of the set of channel measurement resources is a candidate for inclusion in the measurement report for transmission to the network entity, transmit the downlink control information signal triggering the measurement report prior to or after the time duration in accordance with the capability information, and receive the measurement report in response to receiving the downlink control information signal.

Another apparatus for wireless communication at a network entity is described. The apparatus may include means for receiving a capability information indicating that a UE supports reception of a downlink control information signal triggering a measurement report prior to or after a time duration including one or more measurement occasions associated with a set of channel measurement resources, where a respective measurement information for each channel measurement resource of the set of channel measurement resources is a candidate for inclusion in the measurement report for transmission to the network entity, means for transmitting the downlink control information signal triggering the measurement report prior to or after the time duration in accordance with the capability information, and means for receiving the measurement report in response to receiving the downlink control information signal.

A non-transitory computer-readable medium storing code for wireless communication at a network entity is described. The code may include instructions executable by a processor to receive a capability information indicating that a UE supports reception of a downlink control information signal triggering a measurement report prior to or after a time duration including one or more measurement occasions associated with a set of channel measurement resources, where a respective measurement information for each channel measurement resource of the set of channel measurement resources is a candidate for inclusion in the measurement report for transmission to the network entity, transmit the downlink control information signal triggering the measurement report prior to or after the time duration in accordance with the capability information, and receive the measurement report in response to receiving the downlink control information signal.

In some examples of the method, apparatuses, and non-transitory computer-readable medium described herein, receiving the capability information may include operations, features, means, or instructions for receiving, via the capability information, an indication that the UE supports reception of the downlink control information signal triggering the measurement report both prior to and after the time duration.

Some examples of the method, apparatuses, and non-transitory computer-readable medium described herein may further include operations, features, means, or instructions for receiving a further capability information indicating a total number of channel measurement resources associated with the measurement report supported by the UE.

In some examples of the method, apparatuses, and non-transitory computer-readable medium described herein, the set of channel measurement resources may be a subset of the total number of channel measurement resources.

In some examples of the method, apparatuses, and non-transitory computer-readable medium described herein, the total number of channel measurement resources may be based on an average number of channel measurement resources per time duration.

In some examples of the method, apparatuses, and non-transitory computer-readable medium described herein, receiving the capability information may include operations, features, means, or instructions for receiving, via the capability information, an indication that the UE supports reception of the downlink control information signal triggering the measurement report prior to or after the time duration, where the UE supporting reception of the downlink control information signal after the time duration may be based at least part on reception of a prior signal from a network entity, and where the prior signal indicates that the UE may be to expect the downlink control information signal after the time duration.

Some examples of the method, apparatuses, and non-transitory computer-readable medium described herein may further include operations, features, means, or instructions for transmitting a medium access control layer control element (MAC-CE) indicating a set of channel state information triggering states corresponding to the set of channel measurement resources.

Some examples of the method, apparatuses, and non-transitory computer-readable medium described herein may further include operations, features, means, or instructions for transmitting a first medium access control layer control element (MAC-CE) indicating a set of channel state information triggering states and transmitting a second MAC-CE indicating a subset of the set of channel state information triggering states, where the subset of the set of channel state information triggering states corresponds to the set of channel measurement resources.

Some examples of the method, apparatuses, and non-transitory computer-readable medium described herein may further include operations, features, means, or instructions for receiving a further capability information indicating a threshold discontinuous reception periodicity, where the UE supporting reception of the downlink control information signal after the time duration based at least part on the threshold discontinuous reception periodicity.

Some examples of the method, apparatuses, and non-transitory computer-readable medium described herein may further include operations, features, means, or instructions for receiving a further capability information indicating a minimum time duration between a last symbol carrying the downlink control information signal and a starting symbol for the one or more measurement occasions associated with the set of channel measurement resources.

In some examples of the method, apparatuses, and non-transitory computer-readable medium described herein, the minimum time duration may be based on a quantity of channel measurement resources in the set of channel measurement resources.

In some examples of the method, apparatuses, and non-transitory computer-readable medium described herein, receiving the capability information may include operations, features, means, or instructions for receiving, via the capability information, an indication that the UE supports reception of the downlink control information signal triggering the measurement report prior to the time duration.

Some examples of the method, apparatuses, and non-transitory computer-readable medium described herein may further include operations, features, means, or instructions for receiving a further capability information indicating at least one of a minimum time duration between a last symbol carrying the downlink control information signal and a starting symbol for the one or more measurement occasions associated with the set of channel measurement resources, a threshold discontinuous reception periodicity, or a combination thereof.

In some examples of the method, apparatuses, and non-transitory computer-readable medium described herein, the downlink control information signal may be received prior to the minimum time duration between the last symbol carrying the downlink control information and the starting symbol for the one or more measurement occasions associated with the set of channel measurement resources.

In some examples of the method, apparatuses, and non-transitory computer-readable medium described herein, the network entity transmits the downlink control information signal prior to the time duration based at least part on a discontinuous reception periodicity for the time duration being greater than the threshold discontinuous reception periodicity.

### BRIEF DESCRIPTION OF THE DRAWINGS

FIG. 1 illustrates an example of a wireless communications system that supports aperiodic measurement reporting for channel measurement resources in accordance with one or more aspects of the present disclosure.

FIG. 2 illustrates an example of a wireless communications system that supports aperiodic measurement reporting for channel measurement resources in accordance with one or more aspects of the present disclosure.

FIG. 3 illustrates an example of a channel state information triggering state activation that supports aperiodic measurement reporting for channel measurement resources in accordance with one or more aspects of the present disclosure.

FIG. 4 illustrates an example of a process flow that supports aperiodic measurement reporting for channel measurement resources in accordance with one or more aspects of the present disclosure.

FIGS. 5 and 6 illustrate block diagrams of devices that support aperiodic measurement reporting for channel measurement resources in accordance with one or more aspects of the present disclosure.

FIG. 7 illustrates a block diagram of a communications manager that supports aperiodic measurement reporting for channel measurement resources in accordance with one or more aspects of the present disclosure.

FIG. 8 illustrates a diagram of a system including a device that supports aperiodic measurement reporting for channel measurement resources in accordance with one or more aspects of the present disclosure.

FIGS. 9 and 10 illustrate block diagrams of devices that support aperiodic measurement reporting for channel measurement resources in accordance with one or more aspects of the present disclosure.

FIG. 11 illustrates a block diagram of a communications manager that supports aperiodic measurement reporting for channel measurement resources in accordance with one or more aspects of the present disclosure.

FIG. 12 illustrates a diagram of a system including a device that supports aperiodic measurement reporting for channel measurement resources in accordance with one or more aspects of the present disclosure.

FIGS. 13 through 16 illustrate flowcharts showing methods that support aperiodic measurement reporting for channel measurement resources in accordance with one or more aspects of the present disclosure.

### DETAILED DESCRIPTION

Some wireless communications systems may support wireless communications between network nodes, such as a user equipment (UE) (e.g., a first network node) and a network entity (e.g., a second network node). For example, a network entity may transmit reference signals to the UE via one or more beams. In some aspects, the UE may measure a reference signal (such as a synchronization signal block or a channel state information reference signal) in order to determine which one or more beams may be best for communications between the UE and the network entity based on having a highest or strongest measurement. Accordingly, the network entity may transmit the reference signals on multiple different beams while relying on the UE to measure each of the beams and report one or more beams in a measurement report. In some cases, a UE may intentionally skip measurements for certain channel measurement resources based on certain channel measurement resources being too weak or there being a power limitation at the UE.

In some examples, the network entity may additionally transmit the reference signals to sense the wireless communications system (e.g., environment) and predict if a beam blockage may occur. In such cases, the network entity may inform the UE of specific beams to be measured and reported. This can lead to a potential mismatch between the reference signals measured by the UE and the reference signal measurement requested by the network entity. That is, a UE may intentionally skip measuring a reference signal while the network entity may request measurement for that reference signal. This may result in an increased overhead (e.g., increased power consumption, increased resource consumption) at the UE.

Techniques depicted herein enable a UE to efficiently measure reference signals while reducing reporting overhead at a UE. In some examples, the network entity may request measurements for a reference signal after the measurement occasion for the channel measurement resource corresponding to the reference signal. To account for any overhead, the techniques described herein allow for a UE to indicate a capability to receive and act on control signals triggering a measurement report prior to the measurement occasions, after the measurement occasions, or both.

In some examples, the UE may indicate that the UE is able to measure the channel measurement resources if the control signal triggering the measurement report is received before or after the measurement occasion for the channel measurement resources. In some examples, the UE may indicate that the UE is able to measure the channel measurement resources if the control signal triggering the measurement report is received after the measurement occasion for the channel measurement resources given that the UE is previously indicated of such measurements. In some examples, the UE may indicate that the UE is able to measure the channel measurement resources if the control signal triggering the measurement report is received prior to the measurement occasion for the channel measurement resources. Thus, the capability indication may reduce the chance of failed or dropped transmissions and increase the quality of communications between the network entity and the UE.

Aspects of the disclosure are initially described in the context of wireless communications systems. Aspects of the disclosure are further illustrated by and described with reference to a channel state information triggering state activation and a process flow. Aspects of the disclosure are further illustrated by and described with reference to apparatus diagrams, system diagrams, and flowcharts that relate to aperiodic measurement reporting for channel measurement resources.

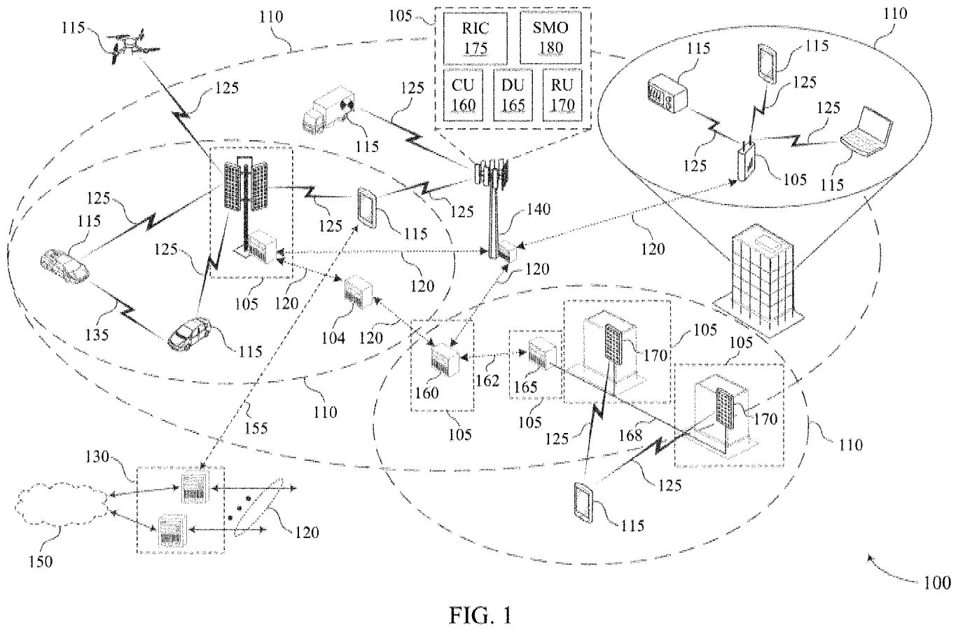

FIG. 1 illustrates an example of a wireless communications system 100 that supports aperiodic measurement reporting for channel measurement resources in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol).

Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN.

Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104.

Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support aperiodic measurement reporting for channel measurement resources as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems (e.g., wireless communications system 100) a UE 115 and a network entity 105 may support artificial intelligence or machine learning based techniques for air-interface corresponding to each target regarding aspects such as performance and complexity. In some examples, such techniques may relate to beam management, such as beam prediction in time, and/or spatial domain for overhead and latency reduction, beam selection accuracy improvement. Additionally, or alternatively, such techniques may be associated with finalizing representative sub uses cases for each use case for characterization and baseline performance evaluations. The artificial intelligence or machine learning based approaches for the selected sub use cases may be diverse enough to support various levels on the network entity and UE collaboration levels. In some examples, the artificial intelligence or machine learning based model and description may be used to identify common and specific characteristics for framework investigations. For instance, the wireless communications system 100 may support characterization of lifecycle management of the artificial intelligence or machine learning based model (e.g., via model training, model deployment, model inference, model monitoring, and model updating).

In some examples, the UE 115 and the network entity 105 may support artificial intelligence or machine learning based beam management techniques. For artificial intelligence or machine learning based beam management, the UE 115 and the network entity 105 may support two cases of beam management for characterization and baseline performance evaluations. In the first case, the UE 115 and the network entity 105 may support spatial-domain downlink beam prediction for a first set (e.g., Set A) of beams based on measurement results of a second set (e.g., Set B) of beams. In the second case, the UE 115 and the network entity 105 may support temporal downlink beam prediction for the first set (e.g., Set A) of beams based on the historic measurement results of the second set (e.g., Set B) of beams. In some examples, beams in Set A and Set B may be in the same frequency range. Additionally, or alternatively, the Set B may be a subset of Set A or Set A and Set B may be different (e.g., Set A may include narrow beams and Set B may include wide beams. In some examples, Set A may be used for downlink beam prediction and Set B may be used for downlink beam measurement.

In some examples, the channel state information reference resource for a serving cell may be defined in the frequency domain, by a group of downlink physical resource blocks corresponding to the band to which the derived channel state information relates. In the time domain, the channel state information reference resource for a channel state information reporting in an uplink slot may be defined by a single downlink slot. When performing measurements, in some examples, the channel measurement resources considered for deriving the measurement report (e.g., using reference signal received power or signal to interference and noise ratio or channel quality indicator or precoding matrix indicator or rank indicator) may be no later than a channel state information reference resource.

In some examples, if a higher layer parameter timeRestrictionForChannelMeasurements is set to “notConfigured,” the UE 115 may derive the channel measurements for computing a channel state information value reported in uplink slot n based on a non-zero power channel state information reference signal, no later than the channel state information reference resource, associated with the channel state information resource setting. Alternatively, if the higher layer parameter timeRestrictionForChannelMeasurements is set to “Configured,” then the UE 115 may derive the channel measurements for computing a channel state information value reported in uplink slot n based on the most recent, no later than the channel state information reference resource, occasion of non-zero power channel state information reference signal.

Additionally, or alternatively, if a higher layer parameter timeRestrictionFor InterferenceMeasurements is set to “notConfigured,” then the UE 115 may derive the interference measurements for computing the channel state information value reported in uplink slot n based on the channel state information interference measurement and/or non-zero power channel state information reference signal for interference measurement, no later than the channel state information reference resource, associated with the channel state information resource setting.

Alternatively, if the higher layer parameter timeRestrictionForInterferenceMeasurements is set to “Configured,” then the UE 115 may derive the interference measurements for computing the channel state information value reported in uplink slot n based on the most recent, no later than the channel state information reference resource, occasion of channel state information interference measurement and/or non-zero power channel state information reference signal for interference measurement.

In some examples, if a higher layer parameter timeRestrictionForChannelMeasurements in CSI-ReportConfig is set to “notConfigured,” then the UE 115 may derive the channel measurements for computing a reference signal received power value reported in uplink slot n based on the synchronization signal or physical broadcast channel or non-zero power channel state information reference signal, no later than the channel state information reference resource, associated with the channel state information resource setting. Alternatively, if the higher layer parameter timeRestrictionForChannelMeasurements in CSI-ReportConfig is set to “Configured,” then the UE 115 may derive the channel measurements for computing a reference signal received power value reported in uplink slot n based on the most recent, no later than the channel state information reference resource, occasion of synchronization signal or physical broadcast channel or non-zero power channel state information reference signal.

In some examples, if a higher layer parameter timeRestrictionForChannelMeasurements in CSI-ReportConfig is set to “notConfigured,” then the UE 115 may derive the channel measurements for computing a signal to interference and noise ratio value reported in uplink slot n based on the synchronization signal or physical broadcast channel or non-zero power channel state information reference signal, no later than the channel state information reference resource, associated with the channel state information resource setting. Alternatively, if the higher layer parameter timeRestrictionFor ChannelMeasurements in CSI-ReportConfig is set to “Configured,” then the UE 115 may derive the channel measurements for computing a signal to interference and noise ratio value reported in uplink slot n based on the most recent, no later than the channel state information reference resource, occasion of synchronization signal or physical broadcast channel or non-zero power channel state information reference signal.

In some examples, if a higher layer parameter timeRestrictionFor InterferenceMeasurements in CSI-ReportConfig is set to “notConfigured,” then the UE 115 may derive the interference measurements for computing a signal to interference and noise ratio value reported in uplink slot n based on the channel state information interference measurement and/or non-zero power channel state information reference signal for interference measurement, no later than the channel state information reference resource, associated with the channel state information resource setting. Alternatively, if the higher layer parameter timeRestrictionForInterferenceMeasurements in CSI-ReportConfig is set to “Configured,” hen the UE 115 may derive the interference measurements for computing a signal to interference and noise ratio value reported in uplink slot n based on the most recent, no later than the channel state information reference resource, occasion of channel state information interference measurement and/or non-zero power channel state information reference signal for interference measurement.

According to one or more aspects, a UE 115 may be configured with a channel state information report setting associated with a channel state information reference signal resource set including multiple channel state information reference signal resources. Additionally, or alternatively, the UE 115 may be configured with a channel state information report setting associated with a synchronization signal block resource set including multiple synchronization signal block resources. In some examples, the report quantity may further be configured by the channel state information report setting including channel characteristics (e.g., reference signal received power or signal to interference and noise ratio or channel quality indicator or precoding matrix indicator or layer indicator or rank indicator) of one or multiple channel state information reference signal or synchronization signal block resources also within the channel state information reference signal or synchronization signal block resource set. The UE 115 may determine which channel state information reference signal or synchronization signal block resource to be addressed in the channel state information report (not necessarily reporting the strongest ones) can be based on at least one of pre-configurations associated with the network entity 105, dynamic indications from the network entity 105, and proactive determinations made by the UE 115.

In some examples, a UE 115 may intentionally skip measurements for certain channel measurement resources. For instance, a large number of channel measurement resources may be configured for a UE 115 and the UE may receive a downlink control information triggering an aperiodic measurement report (or L1 report) to report the top-N strongest reference signal received power values. However, the UE 115 may intentionally skip measurements of certain channel measurement resources based on its own calculations and/or determination (e.g., the UE 115 may determine that certain channel measurement resources are weak and the UE 115 may predict them to be weak for a relatively longer period). In some examples, there may be a power limitation at the UE 115 to calculate reference signal received power values for all configured channel measurement resources. In such cases, the UE 115 may skip measuring one or more channel measurement resources.

In order to allow for beam prediction or blockage prediction at the network entity 105, the channel measurement resources associated with the UE reported reference signal received power values may be dynamically ordered by the network entity 105 (whose reference signal received power values may be weak to guarantee prediction performance at network entity 105). In some instances, a network entity 105 may request measurement report corresponding to particular channel measurement resources using a downlink control information signal. For instance, a UE 115 may receive the downlink control information signal triggering an aperiodic measurement report whose associated channel measurement resources are synchronization signal blocks or periodic or semi-persistent channel state information reference signals, after such channel measurement resource occasions even if the associated timeRestrictionFor InterferenceMeasurements is set to Configured (as the UE 115 is to memorize each occasions'measurement results in case such measurement report is triggered). However, this may lead to inefficiencies, if the downlink control information triggered measurement report with timeRestrictionForInterferenceMeasurements set to Configured, ordered some channel measurement resources that was not measured by the UE 115, or was intentionally skipped by the UE 115.

To enhance robust communications, the wireless communications system 100 may support UE capabilities and related signaling details. Specifically, the UE 115 may indicate whether the UE 115 supports control signal triggered measurement reports. For instance, a UE 115 (e.g., a premium UE) may report its capability indicating that it is able to receive such downlink control information signal triggering the aperiodic measurement report with network entity ordered channel measurement resources after such channel measurement resource occasions. That is, the UE 115 may indicate that the UE 115 would be able to provide the measurement report for a channel measurement resource occasion if the request for such report is received prior to or after the channel measurement resource occasion. In such cases, the UE 115 may measure the channel measurement resources continuously.

Alternatively, the UE 115 (e.g., a mid-tier UE) may report a capability to receive such downlink control information signal triggering the aperiodic measurement report with network entity ordered channel measurement resources after such channel measurement resource occasions on the condition that the network entity 105 indicates beforehand when such a measurement report might be triggered. For instance, That is, the UE 115 may indicate that it would be able to provide the measurement report for a channel measurement resource occasion if the request for such report is received prior to the channel measurement resource occasion. However, the UE 115 may indicate that it would be able to provide the measurement report for a channel measurement resource occasion if the request for such report is received after the channel measurement resource occasion given that it has been previously indicated of such request. Otherwise the mid-tier UE may not expect to receive such downlink control information signals after such channel measurement resource occasions; or this could be further based on power-saving modes implicitly.

In some examples, the UE (e.g., a low-tier UE) may report a to receive such downlink control information signal triggering the aperiodic measurement report with network entity ordered channel measurement resources prior to such channel measurement resource occasions. That is, the low-tier UE may indicate that it is to prepare for the measurements beforehand and thus is capable of providing the measurement report for a channel measurement resource occasion if the request for such report is received prior to the channel measurement resource occasion.

According to one or more aspects depicted herein, the UE 115 may transmit capability information indicating that the UE 115 supports reception of a downlink control information signal triggering a measurement report prior to or after a time duration including one or more measurement occasions associated with a set of channel measurement resources. In some examples, a respective measurement information for each channel measurement resource of the set of channel measurement resources may be a candidate for inclusion in the measurement report for transmission. The UE 115 may receive the downlink control information signal triggering the measurement report prior to or after the time duration in accordance with the capability information. The UE 115 may then transmit the measurement report in response to receiving the downlink control information signal.

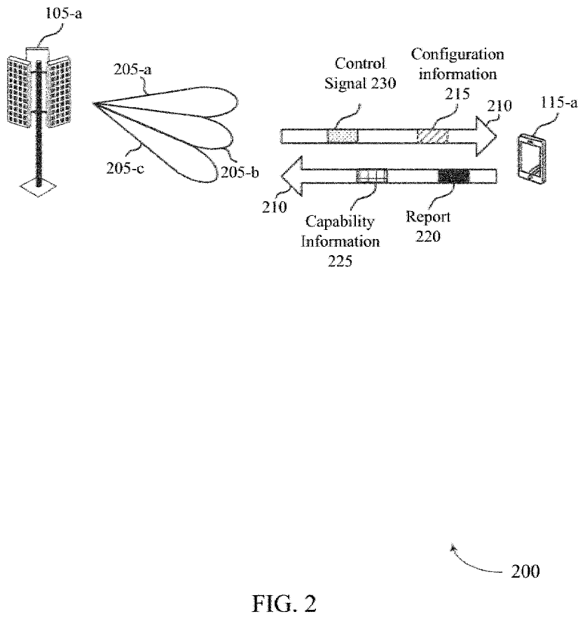

FIG. 2 illustrates an example of a wireless communications system 200 that supports aperiodic measurement reporting for channel measurement resources in accordance with one or more aspects of the present disclosure. The wireless communications system 200 may implement or be implemented by aspects of the wireless communications system 100 described with reference to FIG. 1. For example, the wireless communications system 200 may include a UE 115-a (e.g., a network node) and a network entity 105-a (e.g., a network entity), which may be examples of the corresponding devices described with reference to FIG. 1. The wireless communications system 200 may support improved aperiodic measurement reporting capability, which may support improved communications between the network entity 105-a and the UE 115-a. For example, the wireless communications system 200 may support increased signaling efficiency and reduced power and resource overhead, among other benefits.

The wireless communications system 200 may support communications between the network entity 105-a and the UE 115-a. For example, the network entity 105-a may communicate signals with the UE 115-a over respective communication links 210, which may be an example of a communication link 125 described with reference to FIG. 1. In some cases, the network entity 105-a may transmit one or more reference signals (e.g., synchronization signal blocks, channel state information reference signals) to the UE 115-a via one or beams 205, where each reference signal may be associated with a reference signal resource identifier (e.g., index). In some aspects, transmitting the reference signals may enable the network entity 105-a to sense its environment (e.g., in the wireless communications system 200) and predict whether a beam blockage may occur. In addition, the UE 115-a may measure a reference signal received power or other channel characteristic of one or more of the beams 205 and report the measurement information to the network entity 105-a. For example, the UE 115-a may measure and report reference signal received power values of particular beams to predict beam blockages.

In some aspects, the UE 115-a may receive a channel state information report configuration information 215 that includes a first set of one or more reference signal resource indications, each reference signal resource indication of the one or more reference signal resource indications corresponding to a respective reference signal resource (e.g., a respective) beam 205. That is, a beam 205 may be associated with a channel state information reference signal resource or a synchronization signal block resource. As such, the channel state information report configuration information 215 may identify one or more sets of channel state information or synchronization signal block resource identifiers, where each respective reference signal resource identifiers in the first set may correspond to a respective reference signal resource for which respective measurement information may be included in a report 220 (e.g., a channel state information report) for transmission to the network entity 105-a. For example, the respective reference signal resource identifiers may correspond to a beam 205-a, a beam 205-b, and a beam 205-c.

In some examples, the UE 115-a may transmit capability information 225 to the network entity 105-a. For example, the UE 115-a may transmit capability information 225 indicating that the UE 115-a supports reception of a downlink control information signal triggering a measurement report prior to or after a time duration including one or more measurement occasions associated with a set of channel measurement resources. In some examples, a respective measurement information for each channel measurement resource of the set of channel measurement resources may be a candidate for inclusion in the measurement report for transmission. For example, the channel state information report configuration information 215 may configure or otherwise indicate one or more measurement occasions associated with a set of channel measurement resources. According to one or more aspects, the network entity 105-a may request or trigger a measurement report for at least one of the set of channel measurement resources. To reduce UE overhead and improve reliability, the UE 115-a may indicate whether it supports reception of such measurement request prior to or after the measurement occasion. In some examples, the UE 115-a may receive the downlink control information signal (e.g., control signal 230) triggering the measurement report prior to or after the time duration in accordance with the capability information 225. The UE 115-a may then transmit the measurement report 220 in response to receiving the downlink control information signal.

One or more aspects of the present disclosure provide for UE capabilities for aperiodic measurement report with network entity 105-a requested channel measurement resources. In some examples, the UE 115-a may report at least one timeline capability for an aperiodic measurement report with network entity 105-a requested channel measurement resources, where the timeRestrictionForChannelMeasurements or timeRestrictionFor InterferenceMeasurements associated with the measurement report is set to Configured. In a first example, the UE 115-a may transmit (via the capability information 225) an indication that the UE 115-a is a premium UE and supports reception of a downlink control information signal (e.g., control signal 230) triggering a measurement report both prior to and after the time duration including one or more measurement occasions associated with a set of channel measurement resources. For example, for premium UEs, there may not be further limitation in terms of the time-domain difference, between the starting or ending symbol carrying the downlink control information triggering the aperiodic measurement report, and the slot or symbol carrying measurement occasions for the network entity 105-a requested channel measurement resources. That is, the UE 115-a may indicate that the UE 115-a is capable of providing a measurement report 220 for certain channel measurement resources regardless of whether the control signal 230 requesting the measurement report 220 is received before or after the measurement occasion associated with those channel measurement resources.

In some examples, the premium UE may report its further capability on the total number of channel measurement resources (including at least synchronization signal blocks and non-zero power channel state information reference signals) which are associated with the measurement reports 220 that could order channel measurement resources out of such total number of channel measurement resources, that are simultaneously configured or activated. For example, the UE 115-a may transmit a further capability information indicating a total number of channel measurement resources associated with the measurement report supported by the UE 115-a. In some examples, the set of channel measurement resources may be a subset of the total number of channel measurement resources. Additionally, or alternatively, such total number of channel measurement resources could be further reported based on an average (e.g., based on a duration of a frame or 1 second) number per slot. For example, the total number of channel measurement resources may be based on an average number of channel measurement resources per time duration.

In some examples, the UE 115-a (e.g., mid-tier UE) may transmit, via the capability information 225, an indication that the UE 115-a supports reception of the downlink control information signal (e.g., control signal 230) triggering the measurement report 220 prior to the time duration. The UE 115-a may further indicate that the UE 115-a supports reception of the downlink control information signal (e.g., control signal 230) after the time duration if the UE 115-a receives of a prior signal from the network entity 105-a, where the prior signal indicates that the UE 115-a is to expect the downlink control information signal after the time duration. For instance, in cases of mid-tier UEs, the UE 115-a may be expected to be signaled from the network entity 105-a, on whether it should be prepared to receive such control signal 230 after the slot or symbol carrying the measurement occasions for the network entity 105-a requested channel measurement resources. If the UE 115-a does not receive a prior signaling, it does prepare for providing a measurement report for measurement occasions that occurred prior to receiving the control signal 230. In such cases, the UE 115-a may be expected to receive such a downlink control information signal (e.g., control signal 230) before the measurement occasions for the network entity 105-a requested channel measurement resources.

In some examples, the mid-tier UE 115-a may report its further capability on the total number of channel measurement resources (including at least synchronization signal blocks and non-zero power channel state information reference signals) which are associated with measurement reports 220 that could request measurements for channel measurement resources out of such total number of channel measurement resources, that are simultaneously configured or activated. In some examples, the network entity 105-a may trigger the measurement report 220 after the associated measurement occasions for the channel measurement resources. In some examples, the UE 115-a may further report such total number of channel measurement resources based on an average number per slot. In such cases, the UE 115-a may not be expected to receive such downlink control information signals after the associated measurement occasions for channel measurement resources, if it is configured with discontinuous reception.

In some examples, the UE 115-a may transmit a further capability information indicating a threshold discontinuous reception periodicity. In some cases, the UE 115-a supporting reception of the downlink control information signal (e.g., control signal 230) after the time duration may be based on the threshold discontinuous reception periodicity. For example, the reception of the control signal 230 may be based on a separate UE capability depending on the discontinuous reception periodicity. The UE 15-a may report a threshold discontinuous reception periodicity, such that if the configured discontinuous reception periodicity is greater than the threshold periodicity, UE 115-a is not expected to receive the control signal 230. Otherwise, the UE 115-a would still expect to receive the control signal 230. In such cases, the configured discontinuous reception periodicity may be configured by the network entity 105-a.

Additionally, or alternatively, the UE 115-a may transmit a further capability information indicating a minimum time duration between a last symbol carrying the downlink control information signal (e.g., control signal 230) and a starting symbol for the one or more measurement occasions associated with the set of channel measurement resources. The minimum time duration may be based on a quantity of channel measurement resources in the set of channel measurement resources. For example, in cases where the control signal 230 (e.g., downlink control information signal) triggering measurement reports 220 with network entity 105-a requested channel measurement resources that are received before the associated measurement occasions for channel measurement resources, the UE 115-a may report further capabilities. Such capabilities may be associated with or may include a minimum time difference duration between the last symbol carrying the control signal 230 and the starting symbol with respect to the measurement occasions for the network entity 105-a requested channel measurement resources. In some examples, this could be based on reporting separate capabilities for different candidate number of channel measurement resources within the associated channel measurement resource set (e.g., longer time difference duration may be needed by the UE 115-a to prepare if the total number of channel measurement resources is greater in the channel measurement resource set associated with the measurement report). In some cases, such minimum time difference duration may be predefined.

In some examples, the UE 115-a (e.g., a low-tier UE) may transmit, via the capability information 225, an indication that the UE 115-a supports reception of the downlink control information signal (e.g., control signal 230) triggering the measurement report prior to the time duration. In such cases, the UE 115-a may be expected to receive such a downlink control information signal (e.g., control signal 230) before the measurement occasions for the network entity 105-a requested channel measurement resources. For instance, the UE 115-a may indicate that it supports reception of a control signal 230 requesting measurement for a channel measurement resource prior to a measurement occasion corresponding to such channel measurement resource.

In some examples, the low-tier UE 115-a may transmit a further capability information indicating at least one of a minimum time duration between a last symbol carrying the downlink control information signal (e.g., control signal 230) and a starting symbol for the one or more measurement occasions associated with the set of channel measurement resources, a threshold discontinuous reception periodicity, or a combination thereof. In some cases, the downlink control information signal may be received prior to the minimum time duration between the last symbol carrying the downlink control information signal and the starting symbol for the one or more measurement occasions associated with the set of channel measurement resources. For example, the UE 115-a may report further capabilities, on the minimum time difference duration between the last symbol carrying the control signal 230 (e.g., downlink control information signal) and the starting symbol with respect to the measurement occasions for the network entity 105-a requested channel measurement resources. This could be based on reporting separate capabilities for different candidate number of channel measurement resources within the associated channel measurement resource set (e.g., longer time difference duration may be needed for the UE 115-a to prepare if the total number of channel measurement resources is greater in the channel measurement resource set associated with the measurement report). In some examples, the minimum time difference duration may be predefined.

In some examples, a low-tier UE 115-a may receive the control signal 230 (e.g., downlink control information signal) prior to the time duration including one or more measurement occasions for the network entity 105-a requested channel measurement resources based on a discontinuous reception periodicity for the time duration being greater than the threshold discontinuous reception periodicity the UE 115-a. For example, the UE 115-a may not be expected to receive such downlink control information signal if it is configured with an activated discontinuous reception. This may be further based on a separate UE capability depending on the discontinuous reception periodicity. For instance, the UE 115-a may report a threshold discontinuous reception periodicity, such that if the configured discontinuous reception periodicity is greater than the threshold periodicity, the UE 115-a may not be expected to receive such downlink control information signals. Otherwise, the UE 115-a may still expect to receive such downlink control information signals.

Using the techniques described herein, the UE 115-a may transmit the report 220 to the network entity 105-a including the measurements information, effectively using more than just measurement information corresponding to strongest measured parameters for some beams 205. In fact, the techniques depicted herein provide for utilization of capability information to indicate a capability of a UE 115-a supporting measurement on measurement occasions requested by the network entity 105-a. As such, the network entity 105-a may use the capability information to request measurement report to more accurately predict beam blockages, which may result in fewer failed beams and transmissions and overall improved communications between the network entity 105-a and the UE 115-a.

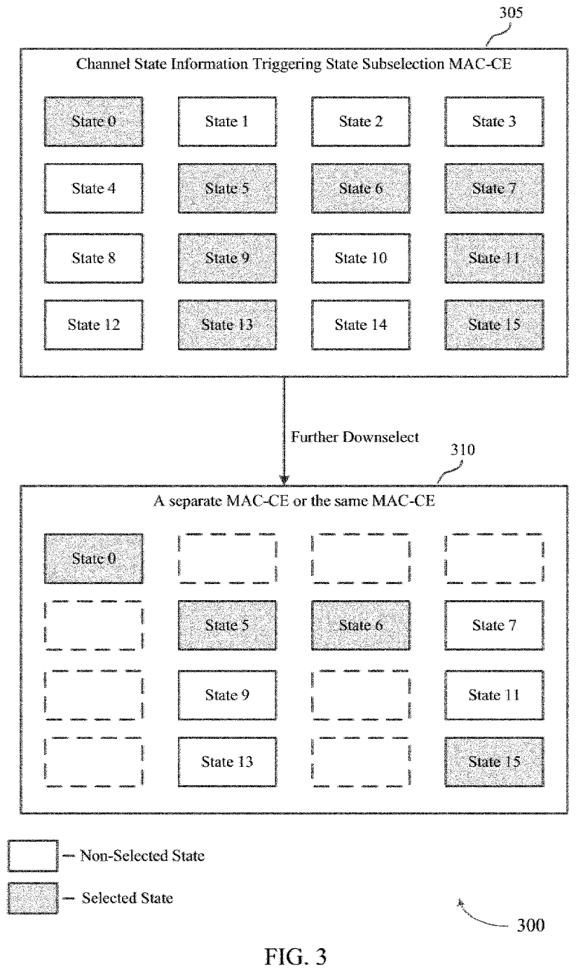

FIG. 3 illustrates an example of a channel state information triggering state activation 300 that supports aperiodic measurement reporting for channel measurement resources in accordance with one or more aspects of the present disclosure. The channel state information triggering state activation 300 may implement or be implemented by aspects of the wireless communications system 100 described with reference to FIG. 1 or the wireless communications system 200 described with reference to FIG. 2. For example, the channel state information triggering state activation 300 may be communicated between a network entity 105 and a UE 115, which may be examples of the corresponding devices described with reference to FIGS. 1 and 2. The channel state information triggering state activation 300 may support improved aperiodic measurement reporting capability resulting in increased signaling efficiency and reduced power and resource overhead, among other benefits.

In some examples, a UE 115 may transmit capability information indicating whether it supports reception of a control signal prior to or after one or more measurement occasions, where the control signal may request a measurement report for channel measurement resources corresponding to the one or more measurement occasions. In some examples, the UE 115 may transmit, via the capability information, an indication that the UE supports reception of a downlink control information signal triggering a measurement report prior to or after a time duration including one or more measurement occasions associated with a set of channel measurement resources. In some examples, the UE 115 supporting reception of the downlink control information signal after the time duration is based on reception of a prior signal from a network entity. In some cases, the prior signal may indicate that the UE 115 is to expect the downlink control information signal after the time duration. In such cases, the UE 115 may receive a MAC control element (MAC-CE) indicating a set of channel state information triggering states corresponding to the set of channel measurement resources.

As depicted in the example of FIG. 3, the UE 115 may receive a MAC-CE 305 indicating a set of channel state information triggering states. In the example of FIG. 3, the MAC-CE 305 may indicate that channel state information triggering state 0, channel state information triggering state 5, channel state information triggering state 6, channel state information triggering state 7, channel state information triggering state 9, channel state information triggering state 11, channel state information triggering state 13, and channel state information triggering state 15 are selected. Additionally, the MAC-CE 305 may indicate that channel state information triggering state 1, channel state information triggering state 2, channel state information triggering state 3, channel state information triggering state 4, channel state information triggering state 8, channel state information triggering state 10, channel state information triggering state 12, and channel state information triggering state 14 are in a non-selected state.

The UE 115 may receive a second MAC-CE 310 to further down select the channel state information triggering states. Alternatively, the same MAC-CE may be used to further down select the channel state information triggering states. For example, the UE 115 may receive a second MAC-CE indicating a subset of the set of channel state information triggering states. In some examples, the subset of the set of channel state information triggering states may correspond to the set of channel measurement resources. According to one or more aspects, a signaling from the network entity 105 whether the UE 115 is to be prepared for receiving downlink control information signals after the measurement occasions for channel measurement resources. In some examples, such signaling or indication may be based on a separate MAC-CE 310, which could also optionally include a number of aperiodic channel state information triggering states that include aperiodic report CSI-AssociatedReportConfigInfo that could dynamically request measurements for channel measurement resources that are already sub-selected by a channel state information triggering state sub-selection MAC-CE 305. In such cases, the UE 115 may only be expected to receive such downlink control information signals after the corresponding measurement occasions for the channel measurement resources associated with the measurement report triggering states that are identified from such an MAC-CE.

Additionally, or alternatively, the UE 115 may receive an enhanced MAC-CE 310 based on the channel state information triggering state sub-selection MAC-CE 305, where the information may include a number of aperiodic channel state information triggering states that include aperiodic report CSI-AssociatedReportConfigInfo that could dynamically request measurements for channel measurement resources that are already sub-selected by a channel state information triggering state sub-selection MAC-CE 305. As depicted in the example of FIG. 3, the MAC-CE 310 may further down-select the channel state information triggering states selected by the MAC-CE 305. In this example, the MAC-CE 310 may indicate that channel state information triggering state 0, channel state information triggering state 5, channel state information triggering state 6, and channel state information triggering state 15 are selected. Additionally, the MAC-CE 310 may indicate that previously selected channel state information triggering state 7, channel state information triggering state 9, channel state information triggering state 11, and channel state information triggering state 13 are not selected.

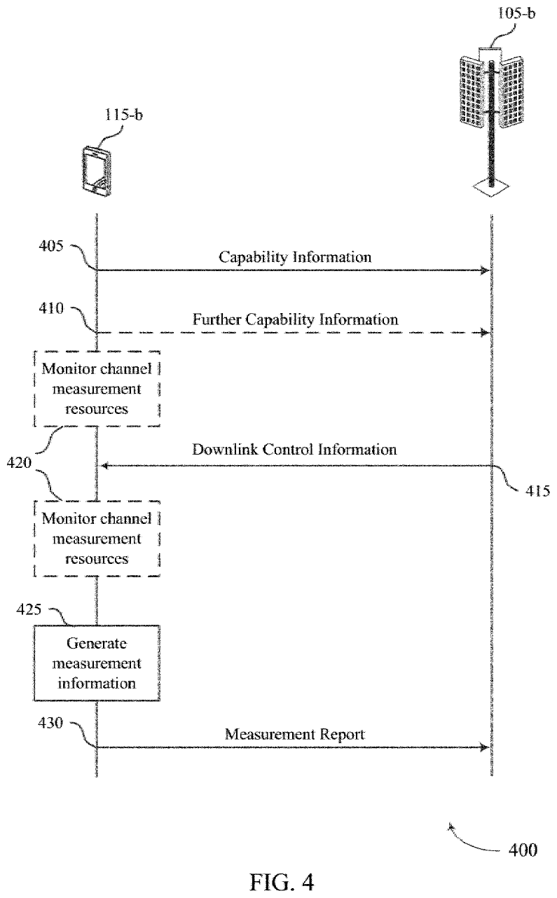

FIG. 4 illustrates an example of a process flow 400 that supports aperiodic measurement reporting for channel measurement resources in accordance with one or more aspects of the present disclosure. The process flow 400 may implement aspects of wireless communications systems 100 and 200, or may be implemented by aspects of the wireless communications system 100 and 200. For example, the process flow 400 may illustrate operations between a UE 115-b (e.g., a first network node) and a network entity 105-b (e.g., a second network node), which may be examples of corresponding devices described herein. In the following description of the process flow 400, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 400, and other operations may be added to the process flow 400.

At 405, the UE 115- b may transmit capability information indicating that the UE supports reception of a downlink control information signal triggering a measurement report prior to or after a time duration including one or more measurement occasions associated with a set of channel measurement resources. In some examples, a respective measurement information for each channel measurement resource of the set of channel measurement resources may be a candidate for inclusion in the measurement report for transmission. In some examples, the UE 115-b may transmit, via the capability information, an indication that the UE supports reception of the downlink control information signal triggering the measurement report both prior to and after the time duration.

Additionally, or alternatively, the UE 115-b may transmit, via the capability information, an indication that the UE 115-b supports reception of the downlink control information signal triggering the measurement report prior to or after the time duration. In some examples, the UE 115-b supporting reception of the downlink control information signal after the time duration may be based on reception of a prior signal from a network entity 105-b. In some examples, the prior signal may indicate that the UE 115-b is to expect the downlink control information signal after the time duration. In some cases, the UE 115-b may transmit, via the capability information, an indication that the UE 115-b supports reception of the downlink control information signal triggering the measurement report prior to the time duration.

At 410, the UE 115- b may optionally transmit a further capability information indicating a total number of channel measurement resources associated with the measurement report supported by the UE 115-b. Although depicted as separate capability information signals, it is to be understood that the information included in the further capability information signal at 410 may instead be conveyed via the capability information signal 405. For example, the capability information signal at 405 may be an enhanced capability information signal indicating a total number of channel measurement resources. In some examples, the set of channel measurement resources may be a subset of the total number of channel measurement resources. In some examples, the total number of channel measurement resources may be based on an average number of channel measurement resources per time duration.

Additionally, or alternatively, the UE 115-b may transmit a further capability information indicating a threshold discontinuous reception periodicity. In some examples, the capability information signal at 405 may be an enhanced capability information signal indicating the threshold discontinuous reception periodicity. The UE 115-b supporting reception of the downlink control information signal after the time duration may be based on the threshold discontinuous reception periodicity. In some examples, the UE 115-b may transmit a further capability information indicating a minimum time duration between a last symbol carrying the downlink control information signal and a starting symbol for the one or more measurement occasions associated with the set of channel measurement resources. In some examples, the capability information signal at 405 may be an enhanced capability information signal indicating the minimum time duration. The minimum time duration may be based on a quantity of channel measurement resources in the set of channel measurement resources. In some examples, the UE 115-b may receive the downlink control information signal prior to the minimum time duration between the last symbol carrying the downlink control information signal and the starting symbol for the one or more measurement occasions associated with the set of channel measurement resources.

Additionally, or alternatively, the UE 115-b may receive the UE receives the downlink control information signal prior to the time duration based on a discontinuous reception periodicity for the time duration being greater than the threshold discontinuous reception periodicity.

At 415, the UE 115-b may receive the downlink control information signal triggering the measurement report prior to or after the time duration in accordance with the capability information.

At 420, the UE 115-b may monitor the set of channel measurement resources and perform channel measurements on the channel measurement resources. Depending on the capability information transmitted at 405 and at 410, the channel measurement resources may occur before or after the downlink control information signal triggering the measurement report is received at the UE 115-b.

At 425, the UE 115-b may generate measurement information based one or more channel measurements performed on one or more of the channel measurement resources. At 430, the UE 115-b may transmit a measurement report containing or indicating the generated measurement information in accordance with the downlink control information signal.

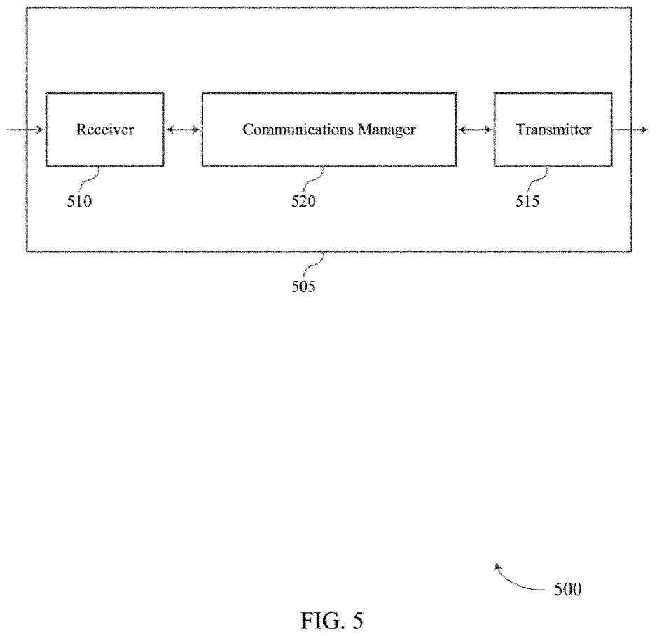

FIG. 5 illustrates a block diagram 500 of a device 505 that supports aperiodic measurement reporting for channel measurement resources in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to aperiodic measurement reporting for channel measurement resources). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to aperiodic measurement reporting for channel measurement resources). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of aperiodic measurement reporting for channel measurement resources as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for transmitting capability information indicating that the UE supports reception of a downlink control information signal triggering a measurement report prior to or after a time duration including one or more measurement occasions associated with a set of channel measurement resources, where a respective measurement information for each channel measurement resource of the set of channel measurement resources is a candidate for inclusion in the measurement report for transmission. The communications manager 520 may be configured as or otherwise support a means for receiving the downlink control information signal triggering the measurement report prior to or after the time duration in accordance with the capability information. The communications manager 520 may be configured as or otherwise support a means for transmitting the measurement report in response to receiving the downlink control information signal.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing, reduced power consumption, and more efficient utilization of communication resources.

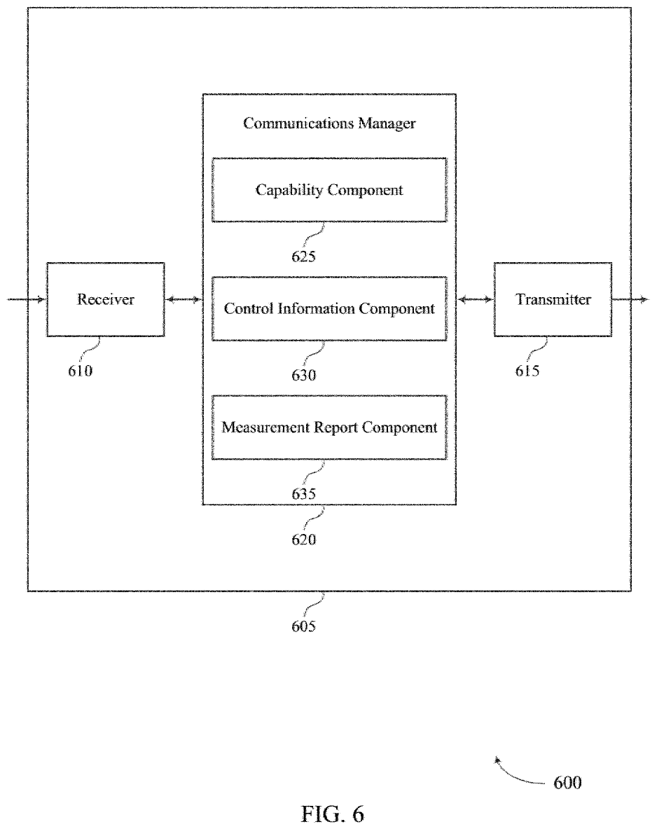

FIG. 6 illustrates a block diagram 600 of a device 605 that supports aperiodic measurement reporting for channel measurement resources in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to aperiodic measurement reporting for channel measurement resources). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to aperiodic measurement reporting for channel measurement resources). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of aperiodic measurement reporting for channel measurement resources as described herein. For example, the communications manager 620 may include a capability component 625, a control information component 630, a measurement report component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The capability component 625 may be configured as or otherwise support a means for transmitting capability information indicating that the UE supports reception of a downlink control information signal triggering a measurement report prior to or after a time duration including one or more measurement occasions associated with a set of channel measurement resources, where a respective measurement information for each channel measurement resource of the set of channel measurement resources is a candidate for inclusion in the measurement report for transmission. The control information component 630 may be configured as or otherwise support a means for receiving the downlink control information signal triggering the measurement report prior to or after the time duration in accordance with the capability information. The measurement report component 635 may be configured as or otherwise support a means for transmitting the measurement report in response to receiving the downlink control information signal.

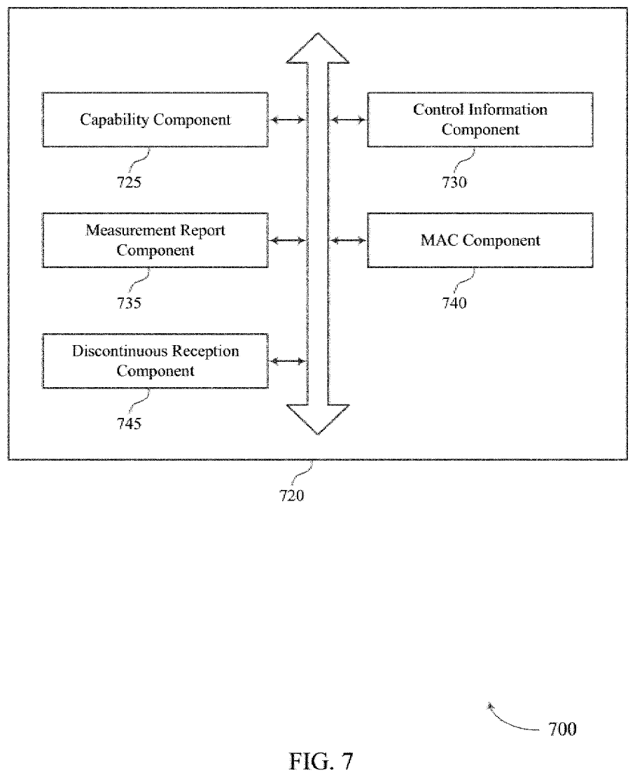

FIG. 7 illustrates a block diagram 700 of a communications manager 720 that supports aperiodic measurement reporting for channel measurement resources in accordance with one or more aspects of the present disclosure. The communications manager 720 may be an example of aspects of a communications manager 520, a communications manager 620, or both, as described herein. The communications manager 720, or various components thereof, may be an example of means for performing various aspects of aperiodic measurement reporting for channel measurement resources as described herein. For example, the communications manager 720 may include a capability component 725, a control information component 730, a measurement report component 735, a MAC component 740, a discontinuous reception component 745, or any combination thereof. Each of these components may communicate, directly or indirectly, with one another (e.g., via one or more buses).

The communications manager 720 may support wireless communication at a UE in accordance with examples as disclosed herein. The capability component 725 may be configured as or otherwise support a means for transmitting capability information indicating that the UE supports reception of a downlink control information signal triggering a measurement report prior to or after a time duration including one or more measurement occasions associated with a set of channel measurement resources, where a respective measurement information for each channel measurement resource of the set of channel measurement resources is a candidate for inclusion in the measurement report for transmission. The control information component 730 may be configured as or otherwise support a means for receiving the downlink control information signal triggering the measurement report prior to or after the time duration in accordance with the capability information. The measurement report component 735 may be configured as or otherwise support a means for transmitting the measurement report in response to receiving the downlink control information signal.

In some examples, to support transmitting the capability information, the capability component 725 may be configured as or otherwise support a means for transmitting, via the capability information, an indication that the UE supports reception of the downlink control information signal triggering the measurement report both prior to and after the time duration.

In some examples, the capability component 725 may be configured as or otherwise support a means for transmitting a further capability information indicating a total number of channel measurement resources associated with the measurement report supported by the UE.

In some examples, the set of channel measurement resources is a subset of the total number of channel measurement resources. In some examples, the total number of channel measurement resources is based on an average number of channel measurement resources per time duration.

In some examples, to support transmitting the capability information, the capability component 725 may be configured as or otherwise support a means for transmitting, via the capability information, an indication that the UE supports reception of the downlink control information signal triggering the measurement report prior to or after the time duration, where the UE supporting reception of the downlink control information signal after the time duration is based at least part on reception of a prior signal from a network entity, and where the prior signal indicates that the UE is to expect the downlink control information signal after the time duration.

In some examples, the MAC component 740 may be configured as or otherwise support a means for receiving a MAC-CE indicating a set of channel state information triggering states corresponding to the set of channel measurement resources. In some examples, the MAC component 740 may be configured as or otherwise support a means for receiving a first MAC-CE indicating a set of channel state information triggering states. In some examples, the MAC component 740 may be configured as or otherwise support a means for receiving a second MAC-CE indicating a subset of the set of channel state information triggering states, where the subset of the set of channel state information triggering states corresponds to the set of channel measurement resources.

In some examples, the discontinuous reception component 745 may be configured as or otherwise support a means for transmitting a further capability information indicating a threshold discontinuous reception periodicity, where the UE supporting reception of the downlink control information signal after the time duration is based at least part on the threshold discontinuous reception periodicity.

In some examples, the capability component 725 may be configured as or otherwise support a means for transmitting a further capability information indicating a minimum time duration between a last symbol carrying the downlink control information signal and a starting symbol for the one or more measurement occasions associated with the set of channel measurement resources. In some examples, the minimum time duration is based on a quantity of channel measurement resources in the set of channel measurement resources.

In some examples, to support transmitting the capability information, the capability component 725 may be configured as or otherwise support a means for transmitting, via the capability information, an indication that the UE supports reception of the downlink control information signal triggering the measurement report prior to the time duration.

In some examples, the capability component 725 may be configured as or otherwise support a means for transmitting a further capability information indicating at least one of a minimum time duration between a last symbol carrying the downlink control information signal and a starting symbol for the one or more measurement occasions associated with the set of channel measurement resources, a threshold discontinuous reception periodicity, or a combination thereof.

In some examples, the downlink control information signal is received prior to the minimum time duration between the last symbol carrying the downlink control information signal and the starting symbol for the one or more measurement occasions associated with the set of channel measurement resources.

In some examples, the UE receives the downlink control information signal prior to the time duration based at least part on a discontinuous reception periodicity for the time duration being greater than the threshold discontinuous reception periodicity.

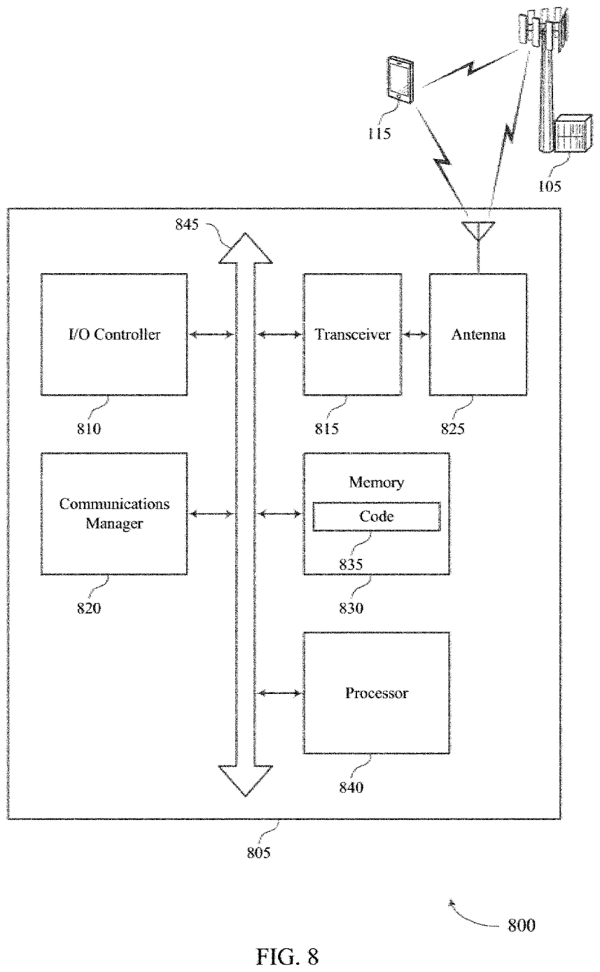

FIG. 8 illustrates a diagram of a system 800 including a device 805 that supports aperiodic measurement reporting for channel measurement resources in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting aperiodic measurement reporting for channel measurement resources). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for transmitting capability information indicating that the UE supports reception of a downlink control information signal triggering a measurement report prior to or after a time duration including one or more measurement occasions associated with a set of channel measurement resources, where a respective measurement information for each channel measurement resource of the set of channel measurement resources is a candidate for inclusion in the measurement report for transmission. The communications manager 820 may be configured as or otherwise support a means for receiving the downlink control information signal triggering the measurement report prior to or after the time duration in accordance with the capability information. The communications manager 820 may be configured as or otherwise support a means for transmitting the measurement report in response to receiving the downlink control information signal.

By including or configuring the communications manager 820 in accordance with examples as described herein, the device 805 may support techniques for improved communication reliability, reduced latency, improved user experience related to reduced processing, reduced power consumption, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of aperiodic measurement reporting for channel measurement resources as described herein, or the processor 840 and the memory 830 may be otherwise configured to perform or support such operations.

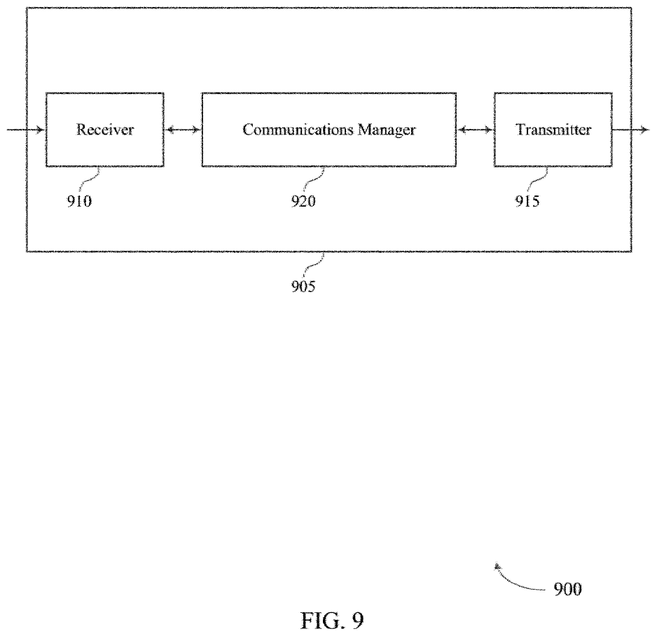

FIG. 9 illustrates a block diagram 900 of a device 905 that supports aperiodic measurement reporting for channel measurement resources in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas.

Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of aperiodic measurement reporting for channel measurement resources as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for receiving a capability information indicating that a UE supports reception of a downlink control information signal triggering a measurement report prior to or after a time duration including one or more measurement occasions associated with a set of channel measurement resources, where a respective measurement information for each channel measurement resource of the set of channel measurement resources is a candidate for inclusion in the measurement report for transmission to the network entity. The communications manager 920 may be configured as or otherwise support a means for transmitting the downlink control information signal triggering the measurement report prior to or after the time duration in accordance with the capability information. The communications manager 920 may be configured as or otherwise support a means for receiving the measurement report in response to receiving the downlink control information signal.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing, reduced power consumption, and more efficient utilization of communication resources.

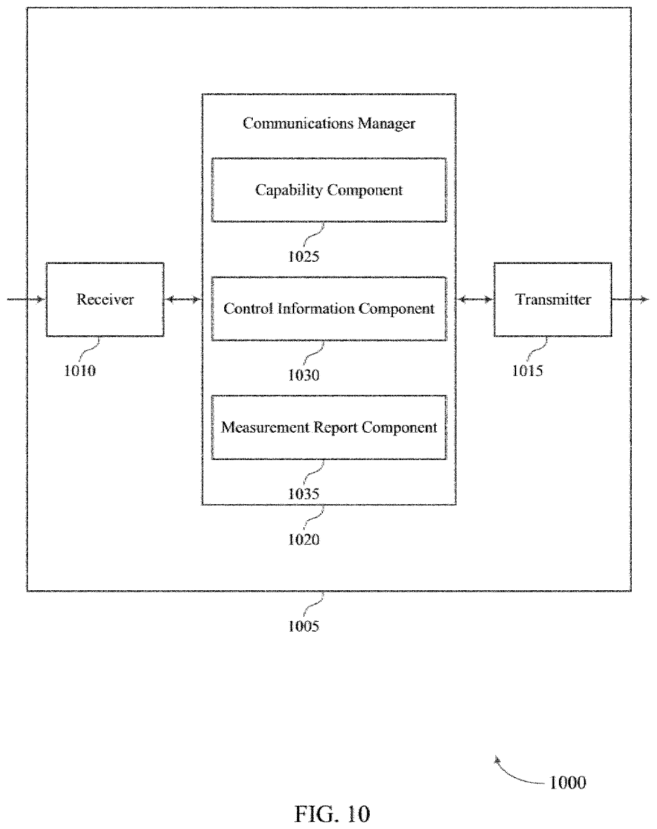

FIG. 10 illustrates a block diagram 1000 of a device 1005 that supports aperiodic measurement reporting for channel measurement resources in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas.

Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of aperiodic measurement reporting for channel measurement resources as described herein. For example, the communications manager 1020 may include a capability component 1025, a control information component 1030, a measurement report component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The capability component 1025 may be configured as or otherwise support a means for receiving a capability information indicating that a UE supports reception of a downlink control information signal triggering a measurement report prior to or after a time duration including one or more measurement occasions associated with a set of channel measurement resources, where a respective measurement information for each channel measurement resource of the set of channel measurement resources is a candidate for inclusion in the measurement report for transmission to the network entity. The control information component 1030 may be configured as or otherwise support a means for transmitting the downlink control information signal triggering the measurement report prior to or after the time duration in accordance with the capability information. The measurement report component 1035 may be configured as or otherwise support a means for receiving the measurement report in response to receiving the downlink control information signal.

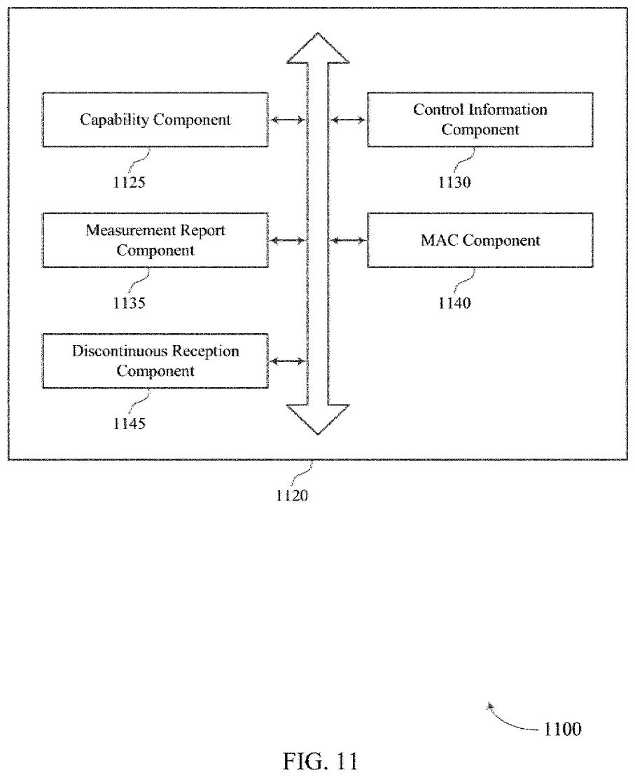

FIG. 11 illustrates a block diagram 1100 of a communications manager 1120 that supports aperiodic measurement reporting for channel measurement resources in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of aperiodic measurement reporting for channel measurement resources as described herein. For example, the communications manager 1120 may include a capability component 1125, a control information component 1130, a measurement report component 1135, a MAC component 1140, a discontinuous reception component 1145, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The capability component 1125 may be configured as or otherwise support a means for receiving a capability information indicating that a UE supports reception of a downlink control information signal triggering a measurement report prior to or after a time duration including one or more measurement occasions associated with a set of channel measurement resources, where a respective measurement information for each channel measurement resource of the set of channel measurement resources is a candidate for inclusion in the measurement report for transmission to the network entity. The control information component 1130 may be configured as or otherwise support a means for transmitting the downlink control information signal triggering the measurement report prior to or after the time duration in accordance with the capability information. The measurement report component 1135 may be configured as or otherwise support a means for receiving the measurement report in response to receiving the downlink control information signal.

In some examples, to support receiving the capability information, the capability component 1125 may be configured as or otherwise support a means for receiving, via the capability information, an indication that the UE supports reception of the downlink control information signal triggering the measurement report both prior to and after the time duration.

In some examples, the capability component 1125 may be configured as or otherwise support a means for receiving a further capability information indicating a total number of channel measurement resources associated with the measurement report supported by the UE.

In some examples, the set of channel measurement resources is a subset of the total number of channel measurement resources. In some examples, the total number of channel measurement resources is based on an average number of channel measurement resources per time duration.

In some examples, to support receiving the capability information, the capability component 1125 may be configured as or otherwise support a means for receiving, via the capability information, an indication that the UE supports reception of the downlink control information signal triggering the measurement report prior to or after the time duration, where the UE supporting reception of the downlink control information signal after the time duration is based at least part on reception of a prior signal from a network entity, and where the prior signal indicates that the UE is to expect the downlink control information signal after the time duration.

In some examples, the MAC component 1140 may be configured as or otherwise support a means for transmitting a MAC-CE indicating a set of channel state information triggering states corresponding to the set of channel measurement resources. In some examples, the MAC component 1140 may be configured as or otherwise support a means for transmitting a first MAC-CE indicating a set of channel state information triggering states. In some examples, the MAC component 1140 may be configured as or otherwise support a means for transmitting a second MAC-CE indicating a subset of the set of channel state information triggering states, where the subset of the set of channel state information triggering states corresponds to the set of channel measurement resources.

In some examples, the discontinuous reception component 1145 may be configured as or otherwise support a means for receiving a further capability information indicating a threshold discontinuous reception periodicity, where the UE supporting reception of the downlink control information signal after the time duration based at least part on the threshold discontinuous reception periodicity.

In some examples, the capability component 1125 may be configured as or otherwise support a means for receiving a further capability information indicating a minimum time duration between a last symbol carrying the downlink control information signal and a starting symbol for the one or more measurement occasions associated with the set of channel measurement resources. In some examples, the minimum time duration is based on a quantity of channel measurement resources in the set of channel measurement resources.

In some examples, to support receiving the capability information, the capability component 1125 may be configured as or otherwise support a means for receiving, via the capability information, an indication that the UE supports reception of the downlink control information signal triggering the measurement report prior to the time duration.

In some examples, the capability component 1125 may be configured as or otherwise support a means for receiving a further capability information indicating at least one of a minimum time duration between a last symbol carrying the downlink control information signal and a starting symbol for the one or more measurement occasions associated with the set of channel measurement resources, a threshold discontinuous reception periodicity, or a combination thereof.

In some examples, the downlink control information signal is received prior to the minimum time duration between the last symbol carrying the downlink control information signal and the starting symbol for the one or more measurement occasions associated with the set of channel measurement resources.

In some examples, the network entity transmits the downlink control information signal prior to the time duration based at least part on a discontinuous reception periodicity for the time duration being greater than the threshold discontinuous reception periodicity.

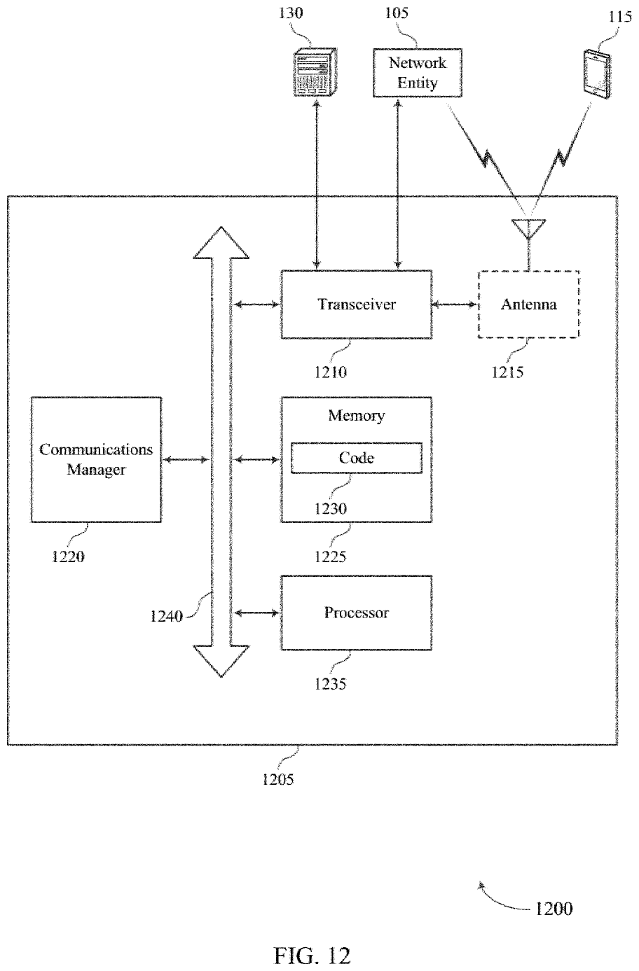

FIG. 12 illustrates a diagram of a system 1200 including a device 1205 that supports aperiodic measurement reporting for channel measurement resources in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting aperiodic measurement reporting for channel measurement resources). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for receiving a capability information indicating that a UE supports reception of a downlink control information signal triggering a measurement report prior to or after a time duration including one or more measurement occasions associated with a set of channel measurement resources, where a respective measurement information for each channel measurement resource of the set of channel measurement resources is a candidate for inclusion in the measurement report for transmission to the network entity. The communications manager 1220 may be configured as or otherwise support a means for transmitting the downlink control information signal triggering the measurement report prior to or after the time duration in accordance with the capability information. The communications manager 1220 may be configured as or otherwise support a means for receiving the measurement report in response to receiving the downlink control information signal.

By including or configuring the communications manager 1220 in accordance with examples as described herein, the device 1205 may support techniques for improved communication reliability, reduced latency, improved user experience related to reduced processing, reduced power consumption, more efficient utilization of communication resources, and improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of aperiodic measurement reporting for channel measurement resources as described herein, or the processor 1235 and the memory 1225 may be otherwise configured to perform or support such operations.

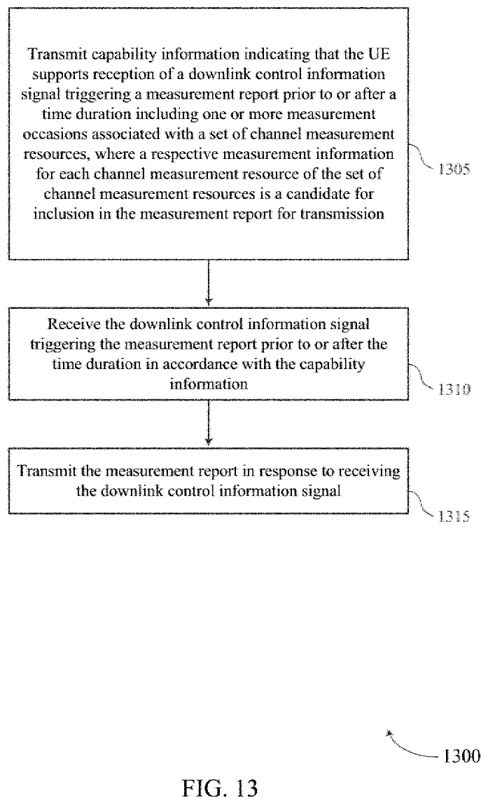

FIG. 13 illustrates a flowchart showing a method 1300 that supports aperiodic measurement reporting for channel measurement resources in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting capability information indicating that the UE supports reception of a downlink control information signal triggering a measurement report prior to or after a time duration including one or more measurement occasions associated with a set of channel measurement resources, where a respective measurement information for each channel measurement resource of the set of channel measurement resources is a candidate for inclusion in the measurement report for transmission. The operations of 1305 may be performed in accordance with examples as disclosed herein. In some examples, aspects of the operations of 1305 may be performed by a capability component 725 as described with reference to FIG. 7.

At 1310, the method may include receiving the downlink control information signal triggering the measurement report prior to or after the time duration in accordance with the capability information. The operations of 1310 may be performed in accordance with examples as disclosed herein. In some examples, aspects of the operations of 1310 may be performed by a control information component 730 as described with reference to FIG. 7.

At 1315, the method may include transmitting the measurement report in response to receiving the downlink control information signal. The operations of 1315 may be performed in accordance with examples as disclosed herein. In some examples, aspects of the operations of 1315 may be performed by a measurement report component 735 as described with reference to FIG. 7.

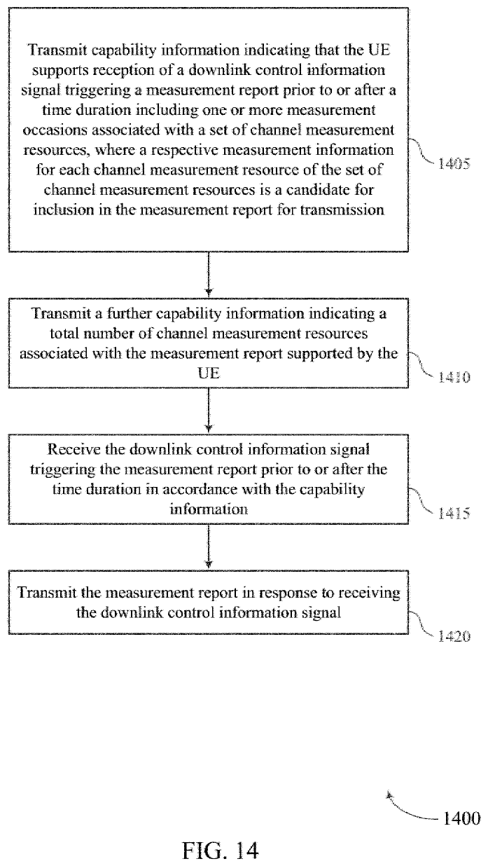

FIG. 14 illustrates a flowchart showing a method 1400 that supports aperiodic measurement reporting for channel measurement resources in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting capability information indicating that the UE supports reception of a downlink control information signal triggering a measurement report prior to or after a time duration including one or more measurement occasions associated with a set of channel measurement resources, where a respective measurement information for each channel measurement resource of the set of channel measurement resources is a candidate for inclusion in the measurement report for transmission. The operations of 1405 may be performed in accordance with examples as disclosed herein. In some examples, aspects of the operations of 1405 may be performed by a capability component 725 as described with reference to FIG. 7.

At 1410, the method may include transmitting a further capability information indicating a total number of channel measurement resources associated with the measurement report supported by the UE. The operations of 1410 may be performed in accordance with examples as disclosed herein. In some examples, aspects of the operations of 1410 may be performed by a capability component 725 as described with reference to FIG. 7.

At 1415, the method may include receiving the downlink control information signal triggering the measurement report prior to or after the time duration in accordance with the capability information. The operations of 1415 may be performed in accordance with examples as disclosed herein. In some examples, aspects of the operations of 1415 may be performed by a control information component 730 as described with reference to FIG. 7.

At 1420, the method may include transmitting the measurement report in response to receiving the downlink control information signal. The operations of 1420 may be performed in accordance with examples as disclosed herein. In some examples, aspects of the operations of 1420 may be performed by a measurement report component 735 as described with reference to FIG. 7.

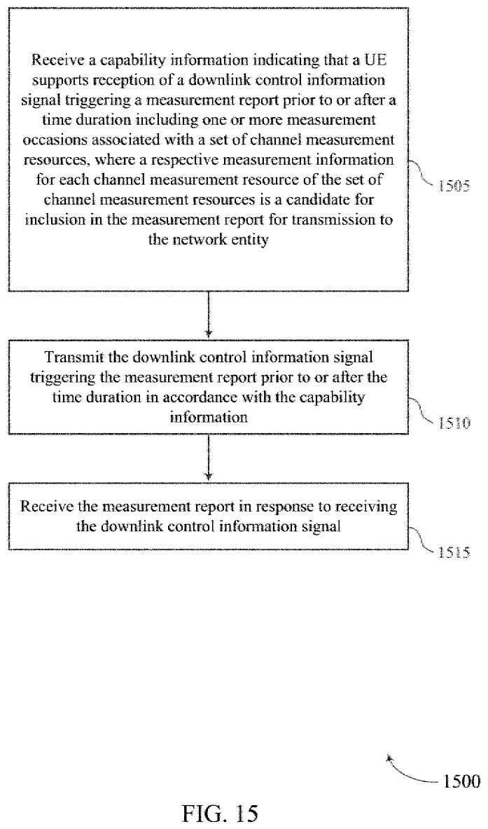

FIG. 15 illustrates a flowchart showing a method 1500 that supports aperiodic measurement reporting for channel measurement resources in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include receiving a capability information indicating that a UE supports reception of a downlink control information signal triggering a measurement report prior to or after a time duration including one or more measurement occasions associated with a set of channel measurement resources, where a respective measurement information for each channel measurement resource of the set of channel measurement resources is a candidate for inclusion in the measurement report for transmission to the network entity. The operations of 1505 may be performed in accordance with examples as disclosed herein. In some examples, aspects of the operations of 1505 may be performed by a capability component 1125 as described with reference to FIG. 11.

At 1510, the method may include transmitting the downlink control information signal triggering the measurement report prior to or after the time duration in accordance with the capability information. The operations of 1510 may be performed in accordance with examples as disclosed herein. In some examples, aspects of the operations of 1510 may be performed by a control information component 1130 as described with reference to FIG. 11.

At 1515, the method may include receiving the measurement report in response to receiving the downlink control information signal. The operations of 1515 may be performed in accordance with examples as disclosed herein. In some examples, aspects of the operations of 1515 may be performed by a measurement report component 1135 as described with reference to FIG. 11.

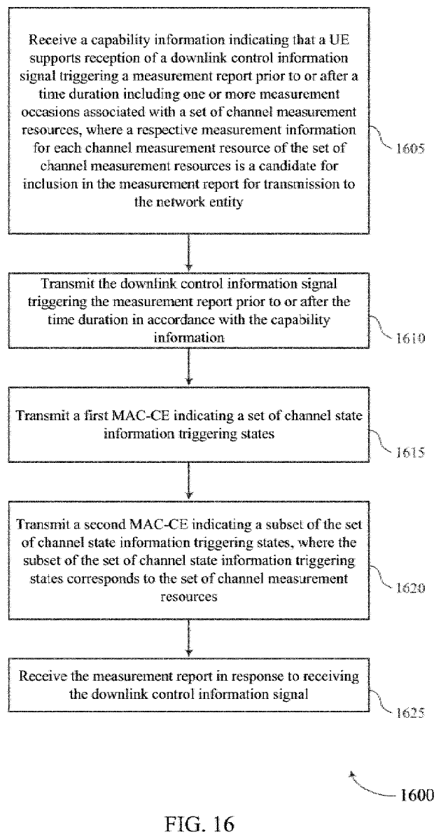

FIG. 16 illustrates a flowchart showing a method 1600 that supports aperiodic measurement reporting for channel measurement resources in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include receiving a capability information indicating that a UE supports reception of a downlink control information signal triggering a measurement report prior to or after a time duration including one or more measurement occasions associated with a set of channel measurement resources, where a respective measurement information for each channel measurement resource of the set of channel measurement resources is a candidate for inclusion in the measurement report for transmission to the network entity. The operations of 1605 may be performed in accordance with examples as disclosed herein. In some examples, aspects of the operations of 1605 may be performed by a capability component 1125 as described with reference to FIG. 11.

At 1610, the method may include transmitting the downlink control information signal triggering the measurement report prior to or after the time duration in accordance with the capability information. The operations of 1610 may be performed in accordance with examples as disclosed herein. In some examples, aspects of the operations of 1610 may be performed by a control information component 1130 as described with reference to FIG. 11.

At 1615, the method may include transmitting a first MAC-CE indicating a set of channel state information triggering states. The operations of 1615 may be performed in accordance with examples as disclosed herein. In some examples, aspects of the operations of 1615 may be performed by a MAC component 1140 as described with reference to FIG. 11.

At 1620, the method may include transmitting a second MAC-CE indicating a subset of the set of channel state information triggering states, where the subset of the set of channel state information triggering states corresponds to the set of channel measurement resources. The operations of 1620 may be performed in accordance with examples as disclosed herein. In some examples, aspects of the operations of 1620 may be performed by a MAC component 1140 as described with reference to FIG. 11.

At 1625, the method may include receiving the measurement report in response to receiving the downlink control information signal. The operations of 1625 may be performed in accordance with examples as disclosed herein. In some examples, aspects of the operations of 1625 may be performed by a measurement report component 1135 as described with reference to FIG. 11.

The following provides an overview of aspects of the present disclosure:

Aspect 1: A method for wireless communication at a UE, comprising: transmitting capability information indicating that the UE supports reception of a downlink control information signal triggering a measurement report prior to or after a time duration comprising one or more measurement occasions associated with a set of channel measurement resources, wherein a respective measurement information for each channel measurement resource of the set of channel measurement resources is a candidate for inclusion in the measurement report for transmission; receiving the downlink control information signal triggering the measurement report prior to or after the time duration in accordance with the capability information; and transmitting the measurement report in response to receiving the downlink control information signal.

Aspect 2: The method of aspect 1, wherein transmitting the capability information further comprises: transmitting, via the capability information, an indication that the UE supports reception of the downlink control information signal triggering the measurement report both prior to and after the time duration.

Aspect 3: The method of aspect 2, further comprising: transmitting a further capability information indicating a total number of channel measurement resources associated with the measurement report supported by the UE.

Aspect 4: The method of aspect 3, wherein the set of channel measurement resources is a subset of the total number of channel measurement resources.

Aspect 5: The method of any of aspects 3 through 4, wherein the total number of channel measurement resources is based at least in part on an average number of channel measurement resources per time duration.

Aspect 6: The method of any of aspects 1 through 5, wherein transmitting the capability information further comprises: transmitting, via the capability information, an indication that the UE supports reception of the downlink control information signal triggering the measurement report prior to or after the time duration, wherein the UE supporting reception of the downlink control information signal after the time duration is based at least part on reception of a prior signal from a network entity, and wherein the prior signal indicates that the UE is to expect the downlink control information signal after the time duration.

Aspect 7: The method of aspect 6, further comprising: receiving a medium access control layer control element (MAC-CE) indicating a set of channel state information triggering states corresponding to the set of channel measurement resources.

Aspect 8: The method of any of aspects 6 through 7, further comprising: receiving a first medium access control layer control element (MAC-CE) indicating a set of channel state information triggering states; and receiving a second MAC-CE indicating a subset of the set of channel state information triggering states, wherein the subset of the set of channel state information triggering states corresponds to the set of channel measurement resources.

Aspect 9: The method of any of aspects 6 through 8, further comprising: transmitting a further capability information indicating a threshold discontinuous reception periodicity, wherein the UE supporting reception of the downlink control information signal after the time duration is based at least part on the threshold discontinuous reception periodicity.

Aspect 10: The method of any of aspects 6 through 9, further comprising: transmitting a further capability information indicating a minimum time duration between a last symbol carrying the downlink control information signal and a starting symbol for the one or more measurement occasions associated with the set of channel measurement resources.

Aspect 11: The method of aspect 10, wherein the minimum time duration is based at least in part on a quantity of channel measurement resources in the set of channel measurement resources.

Aspect 12: The method of any of aspects 1 through 11, wherein transmitting the capability information further comprises: transmitting, via the capability information, an indication that the UE supports reception of the downlink control information signal triggering the measurement report prior to the time duration.

Aspect 13: The method of aspect 12, further comprising: transmitting a further capability information indicating at least one of a minimum time duration between a last symbol carrying the downlink control information signal and a starting symbol for the one or more measurement occasions associated with the set of channel measurement resources, a threshold discontinuous reception periodicity, or a combination thereof.

Aspect 14: The method of aspect 13, wherein the downlink control information signal is received prior to the minimum time duration between the last symbol carrying the downlink control information and the starting symbol for the one or more measurement occasions associated with the set of channel measurement resources.

Aspect 15: The method of any of aspects 13 through 14, wherein the UE receives the downlink control information signal prior to the time duration based at least part on a discontinuous reception periodicity for the time duration being greater than the threshold discontinuous reception periodicity.

Aspect 16: A method for wireless communication at a network entity, comprising: receiving a capability information indicating that a UE supports reception of a downlink control information signal triggering a measurement report prior to or after a time duration comprising one or more measurement occasions associated with a set of channel measurement resources, wherein a respective measurement information for each channel measurement resource of the set of channel measurement resources is a candidate for inclusion in the measurement report for transmission to the network entity; transmitting the downlink control information signal triggering the measurement report prior to or after the time duration in accordance with the capability information; and receiving the measurement report in response to receiving the downlink control information signal.

Aspect 17: The method of aspect 16, wherein receiving the capability information further comprises: receiving, via the capability information, an indication that the UE supports reception of the downlink control information signal triggering the measurement report both prior to and after the time duration.

Aspect 18: The method of aspect 17, further comprising: receiving a further capability information indicating a total number of channel measurement resources associated with the measurement report supported by the UE.

Aspect 19: The method of aspect 18, wherein the set of channel measurement resources is a subset of the total number of channel measurement resources.

Aspect 20: The method of any of aspects 18 through 19, wherein the total number of channel measurement resources is based at least in part on an average number of channel measurement resources per time duration.

Aspect 21: The method of any of aspects 16 through 20, wherein receiving the capability information further comprises: receiving, via the capability information, an indication that the UE supports reception of the downlink control information signal triggering the measurement report prior to or after the time duration, wherein the UE supporting reception of the downlink control information signal after the time duration is based at least part on reception of a prior signal from a network entity, and wherein the prior signal indicates that the UE is to expect the downlink control information signal after the time duration.

Aspect 22: The method of aspect 21, further comprising: transmitting a medium access control layer control element (MAC-CE) indicating a set of channel state information triggering states corresponding to the set of channel measurement resources.

Aspect 23: The method of any of aspects 21 through 22, further comprising: transmitting a first medium access control layer control element (MAC-CE) indicating a set of channel state information triggering states; and transmitting a second MAC-CE indicating a subset of the set of channel state information triggering states, wherein the subset of the set of channel state information triggering states corresponds to the set of channel measurement resources.

Aspect 24: The method of any of aspects 21 through 23, further comprising: receiving a further capability information indicating a threshold discontinuous reception periodicity, wherein the UE supporting reception of the downlink control information signal after the time duration based at least part on the threshold discontinuous reception periodicity.

Aspect 25: The method of any of aspects 21 through 24, further comprising: receiving a further capability information indicating a minimum time duration between a last symbol carrying the downlink control information signal and a starting symbol for the one or more measurement occasions associated with the set of channel measurement resources.

Aspect 26: The method of aspect 25, wherein the minimum time duration is based at least in part on a quantity of channel measurement resources in the set of channel measurement resources.

Aspect 27: The method of any of aspects 16 through 26, wherein receiving the capability information further comprises: receiving, via the capability information, an indication that the UE supports reception of the downlink control information signal triggering the measurement report prior to the time duration.

Aspect 28: The method of aspect 27, further comprising: receiving a further capability information indicating at least one of a minimum time duration between a last symbol carrying the downlink control information signal and a starting symbol for the one or more measurement occasions associated with the set of channel measurement resources, a threshold discontinuous reception periodicity, or a combination thereof.

Aspect 29: The method of aspect 28, wherein the downlink control information signal is received prior to the minimum time duration between the last symbol carrying the downlink control information and the starting symbol for the one or more measurement occasions associated with the set of channel measurement resources.

Aspect 30: The method of any of aspects 28 through 29, wherein the network entity transmits the downlink control information signal prior to the time duration based at least part on a discontinuous reception periodicity for the time duration being greater than the threshold discontinuous reception periodicity.

Aspect 31: An apparatus for wireless communication at a UE, comprising a processor; memory coupled with the processor; and instructions stored in the memory and executable by the processor to cause the apparatus to perform a method of any of aspects 1 through 15.

Aspect 32: An apparatus for wireless communication at a UE, comprising at least one means for performing a method of any of aspects 1 through 15.

Aspect 33: A non-transitory computer-readable medium storing code for wireless communication at a UE, the code comprising instructions executable by a processor to perform a method of any of aspects 1 through 15.

Aspect 34: An apparatus for wireless communication at a network entity, comprising a processor; memory coupled with the processor; and instructions stored in the memory and executable by the processor to cause the apparatus to perform a method of any of aspects 16 through 30.

Aspect 35: An apparatus for wireless communication at a network entity, comprising at least one means for performing a method of any of aspects 16 through 30.

Aspect 36: A non-transitory computer-readable medium storing code for wireless communication at a network entity, the code comprising instructions executable by a processor to perform a method of any of aspects 16 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
one or more processors;
one or more memories in electronic communication with the one or more processors; and
instructions stored in the one or more memories, wherein the instructions are executable by the one or more processors to:
transmit capability information indicating that the UE supports reception of a downlink control information signal triggering a measurement report prior to or after a time duration comprising one or more measurement occasions associated with a set of channel measurement resources, wherein a respective measurement information for each channel measurement resource of the set of channel measurement resources is a candidate for inclusion in the measurement report for transmission;
receive the downlink control information signal triggering the measurement report prior to or after the time duration in accordance with the capability information; and
transmit the measurement report in response to receiving the downlink control information signal.

2. The apparatus of claim 1, wherein the instructions executable by the one or more processors to transmit the capability information comprise instructions executable by the one or more processors to:
transmit, via the capability information, an indication that the UE supports reception of the downlink control information signal triggering the measurement report both prior to and after the time duration.

3. The apparatus of claim 2, wherein the instructions are further executable by the one or more processors to:
transmit a further capability information indicating a total number of channel measurement resources associated with the measurement report supported by the UE.

4. The apparatus of claim 3, wherein the set of channel measurement resources is a subset of the total number of channel measurement resources.

5. The apparatus of claim 3, wherein the total number of channel measurement resources is based at least in part on an average number of channel measurement resources per time duration.

6. The apparatus of claim 1, wherein the instructions executable by the one or more processors to transmit the capability information comprise instructions executable by the one or more processors to:
transmit, via the capability information, an indication that the UE supports reception of the downlink control information signal triggering the measurement report prior to or after the time duration, wherein the UE supporting reception of the downlink control information signal after the time duration is based at least part on reception of a prior signal from a network entity, and wherein the prior signal indicates that the UE is to expect the downlink control information signal after the time duration.

7. The apparatus of claim 6, wherein the instructions are further executable by the one or more processors to:
receive a medium access control layer control element (MAC-CE) indicating a set of channel state information triggering states corresponding to the set of channel measurement resources.

8. The apparatus of claim 6, wherein the instructions are further executable by the one or more processors to:
receive a first medium access control layer control element (MAC-CE) indicating a set of channel state information triggering states; and
receive a second MAC-CE indicating a subset of the set of channel state information triggering states, wherein the subset of the set of channel state information triggering states corresponds to the set of channel measurement resources.

9. The apparatus of claim 6, wherein the instructions are further executable by the one or more processors to:
transmit a further capability information indicating a threshold discontinuous reception periodicity, wherein the UE supporting reception of the downlink control information signal after the time duration is based at least part on the threshold discontinuous reception periodicity.

10. The apparatus of claim 6, wherein the instructions are further executable by the one or more processors to:
transmit a further capability information indicating a minimum time duration between a last symbol carrying the downlink control information signal and a starting symbol for the one or more measurement occasions associated with the set of channel measurement resources.

11. The apparatus of claim 10, wherein the minimum time duration is based at least in part on a quantity of channel measurement resources in the set of channel measurement resources.

12. The apparatus of claim 1, wherein the instructions executable by the one or more processors to transmit the capability information comprise instructions executable by the one or more processors to:
transmit, via the capability information, an indication that the UE supports reception of the downlink control information signal triggering the measurement report prior to the time duration.

13. The apparatus of claim 12, wherein the instructions are further executable by the one or more processors to:
transmit a further capability information indicating at least one of a minimum time duration between a last symbol carrying the downlink control information signal and a starting symbol for the one or more measurement occasions associated with the set of channel measurement resources, a threshold discontinuous reception periodicity, or a combination thereof.

14. The apparatus of claim 13, wherein the downlink control information signal is received prior to the minimum time duration between the last symbol carrying the downlink control information signal and the starting symbol for the one or more measurement occasions associated with the set of channel measurement resources.

15. The apparatus of claim 13, wherein the UE receives the downlink control information signal prior to the time duration based at least part on a discontinuous reception periodicity for the time duration being greater than the threshold discontinuous reception periodicity.

16. An apparatus for wireless communication at a network entity, comprising:
one or more processors;
one or more memories memory in electronic communication with the one or more processors; and
instructions stored in the one or more memories, wherein the instructions are executable by the one or more processors to:
receive a capability information indicating that a user equipment (UE) supports reception of a downlink control information signal triggering a measurement report prior to or after a time duration comprising one or more measurement occasions associated with a set of channel measurement resources, wherein a respective measurement information for each channel measurement resource of the set of channel measurement resources is a candidate for inclusion in the measurement report for transmission to the network entity;
transmit the downlink control information signal triggering the measurement report prior to or after the time duration in accordance with the capability information; and
receive the measurement report in response to receiving the downlink control information signal.

17. The apparatus of claim 16, wherein the instructions executable by the one or more processors to receive the capability information comprise instructions executable by the one or more processors to:
receive, via the capability information, an indication that the UE supports reception of the downlink control information signal triggering the measurement report both prior to and after the time duration.

18. The apparatus of claim 17, wherein the instructions are further executable by the one or more processors to:
receive a further capability information indicating a total number of channel measurement resources associated with the measurement report supported by the UE.

19. The apparatus of claim 18, wherein the set of channel measurement resources is a subset of the total number of channel measurement resources.

20-28. (canceled)

29. A method for wireless communication at a user equipment (UE), comprising:
transmitting capability information indicating that the UE supports reception of a downlink control information signal triggering a measurement report prior to or after a time duration comprising one or more measurement occasions associated with a set of channel measurement resources, wherein a respective measurement information for each channel measurement resource of the set of channel measurement resources is a candidate for inclusion in the measurement report for transmission;
receiving the downlink control information signal triggering the measurement report prior to or after the time duration in accordance with the capability information; and
transmitting the measurement report in response to receiving the downlink control information signal.

30. (canceled)
